(19) United States
(12) Patent Application Publication
(10) Pub. No.: US 2009/0314185 A1
(43) Pub. Date: Dec. 24, 2009

(54) TREATMENT OF FLY ASH

(75) Inventor: John G. Whellock, Castle Rock, CO (US)

Correspondence Address: MARSH, FISCHMANN & BREYFOGLE LLP, 8055 East Tufts Avenue, Suite 450, Denver, CO, 80237, US

(73) Assignee: MATRIX LLC, Castle Rock, CO (US)

(21) Appl. No.: 12/427,550

(22) Filed: Apr. 21, 2009

Related U.S. Application Data
(63) Continuation-in-part of application No. 11/974,905, filed on Oct. 16, 2007.
Application No. 11/974,905 is a continuation-in-part of application No. 11/974,934, filed on Oct. 16, 2007.
Application No. 11/974,934 is a continuation-in-part of application No. PCT/US2007/022209, filed on Oct. 17, 2007.
(60) Provisional application No. 60/852,318, filed on Oct. 17, 2006.
(60) Provisional application No. 60/852,318, filed on Oct. 17, 2006.
(60) Provisional application No. 60/852,318, filed on Oct. 17, 2006.

(51) Int. Cl. C04B 18/06; C25B 1/00; B01J 19/12

(52) U.S. Cl. 106/405; 204/174; 204/157.45

(57) ABSTRACT

Treated carbon-containing fly ash with reduced surfactant-adsorbing capacity is prepared by processing involving contacting the fly ash with ionized gas prepared from a humid gas feed, such as humid air. Treated fly ash with reduced ammonia content is prepared by processing involving contacting the fly ash with ionized gas prepared from a humid gas feed, such as humid air, or exposing the fly ash to microwave radiation or ultraviolet radiation.

### CROSS-REFERENCE TO RELATED APPLICATIONS

This application is a continuation-in-part of U.S. patent application Ser. No. 11/974,905 entitled “Plasma Treatment Of Fly Ash From Coal Combustion To Improve Its Marketability” filed Oct. 16, 2007, which claims priority to U.S. provisional patent application 60/852,318 entitled “Treatment Of Fly Ash From Coal Combustion To Improve Its Marketability” filed Oct. 17, 2006.

This application is a continuation-in-part of U.S. patent application Ser. No. 11/974,934 entitled “Treatment Of Fly Ash From Coal Combustion To Improve Its Marketability” filed Oct. 16, 2007, which claims priority to U.S. provisional patent application 60/852,318 entitled “Treatment Of Fly Ash From Coal Combustion To Improve Its Marketability” filed Oct. 17, 2006.

This application is a continuation-in-part of International Patent Application No. PCT/US2007/022209 entitled “Treatment Of Fly Ash From Coal Combustion To Improve Its Marketability” filed Oct. 17, 2007, which claims priority to U.S. provisional patent application 60/852,318 entitled “Treatment Of Fly Ash From Coal Combustion To Improve Its Marketability” filed Oct. 17, 2006.

The contents of each and every one of U.S. patent application Ser. No. 11/974,905, U.S. patent application Ser. No. 11/974,934 and International Patent Application No. PCT/US2007/022209 is incorporated herein by reference as if each and every part thereof were set forth herein.

### BACKGROUND OF THE INVENTION

1. Field of Invention

Coal combustion fly ash has been marketed for a variety of applications. The addition of fly ash to cement is an expanding industry and accounts for a huge opportunity for the coal burning power plants to defray operating costs for disposal. However if the ash does not meet certain guidelines in terms of residual carbon; or has surfactant adsorption problems-measured in terms of a foam index; or contains ammonia, the fly ash is not only unusable but becomes a disposal problem. This application is concerned with ways and means to treat fly ash and improve its properties, use and value.

2. Background

Fly ash derived from power plants is frequently used in the production of concrete. According to the relevant ASTM requirements, fly ash may replace cement in concrete up to 5-10%. Generally speaking if the carbon in the fly ash were less than 3% w/w (usually measured as loss in ignition or LOI, which closely correlates with the carbon content) it would be marketable. This is common with the C class ashes, which are generally from sub-bituminous coals. Quite often the bituminous coals, which lead to F class ashes, have much higher carbon levels and may in any event be unmarketable unless the carbon is burned out or removed by a separation process.

In the preparation of concrete known as “ready mix” air-entraining agents are used to allow the introduction of micro bubbles into the concrete. These micro bubbles aid in the control of expansion and contraction of the concrete as occurs with freeze and thaw in the environment. Too much air entrained in the concrete reduces strength and too little results in poor adaptation to the above weathering impacts. Many of the ashes can have a seemingly low carbon or LOI level and yet have a problem with the quantity of surfactant required to entrain micro bubbles. It has been determined that it is the carbonaceous residual in fly ash impacts the adsorption of surfactants. This carbon has a high surface area and is very active towards the so-called air entraining agents.

The normal cause of the problem with the fly ash is: low and ultra low NOx burner systems starve the combustion of the coal in the primary firing zone and then add over-fire air to complete oxidation. While minimizing NOx formation these conditions can create higher levels of condensed organic carbonaceous intermediates or soot in or on the fly ash, as well as incompletely combusted particles of (devolatilized) coal. They are effectively incomplete combustion products of the carbon. The remaining mineral matter then has a significant quantity of both coarse (−50 microns) and nano-particulate carbon intermingled with it. This material has a tendency to adsorb the surfactants or air entraining agents causing a high “foam index” and it is thought that it is the finer particles that create most of the problem. This high foam index relates to the number of drops of a standard surfactant that is added to a known quantity of fly ash under controlled conditions. A high foam index material requires much more surfactant than normally necessary.

It is not often clear whether the cause of the high foam index is the reducing conditions in the combustion zone, the residence time of solids in the gas phase, or the load on the boiler unit. It is most probably a function of the specific surface area per unit volume of the carbon, which is related inversely to the particle size (diameter). These effects are not fully understood. Suffice it to say, there are many plants that have this problem with their fly ash. They are struggling to find a solution to overcome the issue so the ash may be sold rather than disposed. Additionally, the situation is worsened by the lack of knowledge of the correlation with the potential causes and the variability of the foam index value. It will be clear to the reader that the variable nature of the foam index will lead to an unknown or un-quantifiable amount of air entraining agent—one minute the amount added if constant might be too much and the next too little.

Another problem with fly ash arises from the presence of ammonia. If too high a concentration is present in the fly ash it may release upon addition of water and the other cement components leading to deleterious environmental consequences. Emission of ammonia is not only unpleasant in closed-in working environments; it is also toxic in high enough concentrations.

Ammonia in fly ash from power plants is created by the injection of ammonia to remove NOx. This technique is employed with Selective Catalytic Reduction (SCR) units. These control devices employ special catalysts, which combine ammonia with NOx components and form harmless nitrogen and water. Some stoichiometric excess is needed to assure the removal of the NOx, but over-injection creates ammonia “slip”, as it is referred to, which results in high local concentrations of the undesirable component adsorbed onto the particulates (or fly ash) in the gas stream. A material so affected is difficult to sell into the concrete market.

These two problems occur in fly ash resulting from coal burning power plants where there are emission control features installed on the boilers. There are innumerable cases where there is need for correction of the either of the two issues and sometimes both on the same plant.

Thermal oxidation is a process that can remove both the ammonia and the carbon foam index issue. Indeed, carbon burn out facilities have been constructed that will take the carbon content and burn it to a low level and it is known that the foam index problem is destroyed under these circumstances. Temperatures for such processes are generally in the region of 700-850° C. Ammonia is also broken down by thermal oxidation means and this can take place at lower temperatures around 350 to 500° C.

Where the foam index issue has to be addressed without real burnout of the carbon (usually because there is insufficient to provide combustible heat release of any magnitude) the foam index can be ameliorated or lessened by thermal treatment at temperatures as low as 400° C. but generally more like 700° C. Naturally the requirement to heat up the fly ash to any of these temperatures results in the expenditure of quite a lot of energy or fuel. Some of this can of course be recovered in the gas stream to preheat the feed air for the combustion process, but nevertheless the demand for fuel is quite significant.

For the treatment of foam index problems, Hurt et al U.S. Pat. Nos. 6,136,089 and 6,521,037 have proposed and patented the use of ozone. This has the advantage of being applied at low temperatures negating the fuel requirements of a truly thermal or combustion process. The dosage rates are relatively high, though, and the use of ozone has an energy demand of its own.

First, the production of ozone is inefficient due to side reactions and the overall power required for a reasonable concentration is quite significant. Secondly, ozone is made from an air stream or an oxygen stream or a mixture of both—but the gas must be almost completely dry (free of water). The generally known conditions for its production are a low dew point of −40° C. or lower in the gas stream, as it is unstable in moist air. Hence, an important part of the power consumed in its generation comes from the drying of the air stream to low dew points. Alternatively, oxygen may be used (which has an inherently low dew point due to the manufacturing processes—from cryogenics or pressure swing methods both of which eliminate water from the gas as an early step in the process chain). However, the power for production of oxygen has to be taken into account—this can range from about 200-400 kWh/ton. Oxygen enables higher concentrations of ozone to be made. Ozone made from oxygen can, for example, be as high as 1-6% w/w. Whereas the concentration level is significantly lower with air perhaps 200 ppm to 5,000 or 10,000 ppm.

The reaction, which produces ozone from a corona discharge in air or oxygen, is quite endothermic. The inefficiencies in the process lead to the release of energy as heat. This heat must be removed from the gas during production. If this heat is not removed, by a cooling circuit, the ozone breaks down—and effectively the product concentration is lowered significantly. The cost associated with the cooling duty is an additional power load and is often not figured in the production cost of ozone generators. This is the third source of cost.

Lastly, the capital cost of ozone generators is significant, as they require close tolerance in manufacture for fitting the dielectric inserts and electrodes within the tubular arrays in a concentric manner. This impacts the overall operating cost in terms of depreciation charges.

The power associated with production is in the range of 9 to 18 kWh/kg of ozone: this, coupled with the relatively high dosage rate required for fly ash treatment, can make this quite an expensive proposition.

Hurt et al identified the conditions for use of the gas to oxidize the carbonaceous material on some fly ash materials tested. To achieve the desired effect for foam index reduction, dosage ranges from 0.5 to 2 or 3 g of ozone/kg of fly ash. Ozone is toxic and needs to be utilized fully or broken down into atmospheric oxygen after the atomic oxygen has taken part in the reaction step. This in itself requires very careful management of the contacting and dosage rate or a back up catalytic breakdown system using manganese dioxide or thermal treatment to about 300° C. At the latter temperature, the residual ozone is reduced to negligible levels.

The authors also elaborated on the mechanism and noted that the actual LOI figure increased with the ozone application. This implies a different mechanism from a breakdown of carbonaceous material into components such as carbon dioxide and water vapor unless they are still held as by-products on the surface.

In international patent WO 02/097330 A1J.M, Tranquilla discloses the use of a microwave reactor together with a carbon-free material and oxygen contacting for reduction of the carbon content in high carbon fly ash. However, the operating temperatures employed with the technique are above 600° C., which leads to the expenditure of significant microwave energy for its attainment. This is, therefore, a variant on a high temperature process for burnout of carbon in fly ash. While this process reduces the carbon content significantly, it is not specifically targeted at lowering the foam index or ammonia removal. The low temperature and energy requirement is the stated objective of this present application.

Another form of energy that has been applied to accelerate reactions and, in particular, oxidations in the field of organic chemistry and wastewater treatment is ultraviolet radiation. However, this has insufficient energy, at close to ambient temperatures, to engage in burnout processes. It also requires relatively accessible surfaces, high surface area, thin layers of material, if the material is solid, or rapid material exchange within the body of the material to be effective.

Other inventors have sought to utilize chemical injection or spray treatment to modify the surface of the fly ash and passivate the fly ash surfactant demand. While this is a low temperature application, which minimizes the energy and is applied to dry fly ash, it has possible future unpredictable consequences for the concrete. Dosing and application rate are a practical issue, which are difficult to control with material that is being transferred at high rate into tankers for dispatch. Generally there is poor penetration into the heart of the flowing mass. The chemicals themselves are potentially hazardous if spilled in transit and are often aliphatic or aromatic carboxylic acids and their salts—see U.S. Pat. No. 6,599,358.

### SUMMARY OF THE INVENTION

The present application seeks to beneficiate a variety of different coal burning power plant fly ash materials that either have a high foam index problem or are contaminated with ammonia or a combination of these issues and are not marketable into the cement/concrete industry. It also seeks to overcome the shortcomings of the aforementioned methods and provide a safe, economical method of treatment of ash.

In the methodology of the present application, a surface blocking mechanism is employed that minimizes the energy requirements for processing the ash. It does not require heating. The treatment only modifies superficial layers of the fly ash while the gaseous agent itself has a half-life that is measured in seconds or at most minutes. Fly ash is a commodity and cannot stand high costs in processing to bring it into a marketable state. Accordingly, what is proposed in this application is specifically a low cost method of upgrading the ash merely by localized surface treatment of the offending carbon. The unique aspect of the application is the careful administration of ionized air generated from ambient humid air for ionic treatment of the surface of the carbon utilizing a contacting method and environment operating at, or close to, ambient temperature. (Air is specifically mentioned due to its low cost, although oxygen or oxygen-enriched air may be used, provided there is sufficient humidity in it). Thus, the operational cost of heating material and the associated capital cost of thermal equipment is avoided.

| | Dosage g/kg of fly ash | | | | | | | |
|---|---|---|---|---|---|---|---|---|
| | Ionized Air | | | | | | | |
| | 0.004 | | 0.39 | | 0.77 | | 1.55 | |
| Method | Input | Output | Input | Output | Input | Output | Input | Output |
| Foam Index | 95 | 70 | 95 | 30 | 100 | 25 | 95 | 15 |

| | | | | |
|---|---|---|---|---|
| Reduction | 26.3% | 68.4% | 75.0% | 84.2% |

| | Dosage g/kg of fly ash | | | | | | | |
|---|---|---|---|---|---|---|---|---|
| | Ozone | | | | | | | |
| | 0.31 | | 0.61 | | 1.22 | | | |
| Method | Input | Output | Input | Output | Input | Output | 3.06 | |
| Foam Index | 95 | 85 | 105 | 80 | 105 | 90 | 95 | 80 |

| | | | | |
|---|---|---|---|---|
| Reduction | 10.5% | 23.8% | 14.3% | 15.7% |

An example of foam index treatment on a specific C-type fly ash is given below. The initial foam index was successfully reduced by ionized ambient air having a relative humidity of approximately 50% by the amounts shown in the table.

It should be noted that the target of foam index in this particular case is approximately 30. (In some instances, the measurements are made in milliliters rather than drops, as shown) However, the relative reduction is the indicator of the efficiency. For ionized air, the dosage rate reflects the equivalent ionic oxidizing power in g per kg of ash. Whereas with ozone it is the actual grams of O₃ passed through so many grams of sample—expressed as g/kg.

While there is some scatter in the results with dry ozone, it should be noted that on the same material and weight treated, the ozone tests did not achieve more than 24% reduction at a dose of 0.61 g/kg and never reached the desired reduction of around 70% even at much higher dosage rates up to 3.1 g/kg. By contrast, the ionized air reached the targeted value (30 drops) with only 0.39 g/kg—one eighth of the concentration of ozone, which in the highest dosage only reached 15.7% reduction (to 80 drops). Comparing the lightest dose of ionized air (0.004) against the heaviest of ozone (3.06) indicates the ability to exceed the performance of ozone on this material with over 700 times lower dosage.

To demonstrate whether there was a long-term effect of ionized air, a number of samples that were previously treated and retained for a year were retested for foam index. These samples had lower or similar foam index results, demonstrating that there was perhaps a permanent change or at least a long-term effect on the material, sufficient to assure its marketability. However, a sample treated with ozone, tested a year later, did not show the same effect. The fly ash material needs to be tested to establish dosing rates and in certain cases dosage may be increased to treat material that has both foam index and high ammonia.

The disclosed system and method seeks to avoid a number of the issues noted with the above prior art in the following way:

Compared with Thermal Routes—
No fuel and much less overall energy is anticipated for the new process
The system can be applied with relatively simple gas/solid contactors without special construction requirements
   Compared with the Ozone Route—
No expensive drying system to low dew points is needed
Some residual moisture level in the gas or the solid is an advantage
Humid or ambient air may be utilized (or oxygen but only to speed up the effect)
Dosage rates less than with ozone
The toxic excess is totally eliminated or greatly reduced
No expensive break down system or use of heat is required for excess reactant
The system will work with both FI (foam index) problems and ammonia
The final breakdown products are innocuous

Furthermore, if compared to some of the proposed options for introducing special surfactant-modifying chemicals, which incidentally have undergone no long term monitoring of their effect on resultant concrete properties, the technique leaves no registerable by-products or modifying chemicals. It has a short life in its effect and the by-product is oxygen. Hence, there is no deleterious effect on the concrete or cementitious properties of the ash when mixed with cement. In addition, as the reactant is administered in a gaseous form there is less risk of poor dosing rate or coverage leading to quality control issues. With the present methodology, once the correct dose is established from tests on the ash initially, the method is not prone to the “hit and miss” syndrome with liquid injection or spray methods of applying chemicals. These systems lead potentially to downstream chemical component issues in the concrete mix.

The ionized air can be generated through a device, which for example, has planar or concentric arrays of electrodes, without a dielectric intermediary to nullify the power arc or thermal discharge of the device. It does not require dried air or oxygen, which are needed for ozone—e.g. dew points of −40° C. for example. The presence of the moisture is beneficial in stabilizing the plasma gas that is generated. The electrical field creates ionic oxygen species and hydroxyl ions, which are highly reactive on suitable targets. These ions effectively block the surface of the active carbon sites. This ionic gas will not significantly react with massive carbon that is present from incomplete combustion burnout of the original coal particles. Hence, negligible change in loss on ignition is effected. Carbon burnout is not the objective.

The ionized gas will furthermore progressively attack adsorbed ammonia on sites on the surface of the carbon and mineral matter and complete the reaction of this to form innocuous nitrogen and water vapor. Hence, ionized air is capable of providing a solution to the oxidation and treatment of fly ash that is presently problematic and incapable of being sold due to either ammonia or foam index issues or both of these problems.

Other types of device including those with dielectric barriers and corona discharge or pulsed mechanisms can also generate ionized air. It is important that the excitation voltage and frequency, with the water vapor present, lead to ionized components, free radicals and hydroxyl ions, which take part rapidly in carbon surface reactions. Some of these are said to be at least two orders of magnitude more powerful than molecular ozone as reacting species.

The ionized air or ionized oxygen is not the low-level or background ionized air that is found frequently in domestic products for allergy or dust treatment. These devices have insufficient energy level to bring about the necessary reactions. This product is made from a high frequency wave. It can be sinusoidal but is preferably square, and creates an alternating electrical field that has 7-20 kV of peak voltage and a rise and fall time that exceeds 106 volts/sec. The frequency and shape of the wave generator assure that the power arc cannot develop before the voltage potential is cut-off. The repeated excitation of the atoms produces a large number of ions in the cold plasma gas. While a dielectric may still be utilized in some designs, the manufacturing costs are minimized by eliminating the tolerance issues associated with ceramic tubes or quartz dielectrics, which must be made concentric in geometry with the outer and inner electrodes. Dielectric barriers only serve to diffuse the power and prevent arcing in a plasma reactor—creating a so-called low temperature corona discharge—about 7000K or less.

A discussed previously, the presence of moisture or H₂O in the gas stream is actually beneficial. Many of the incoming H₂O molecules form hydroxyl ions or radicals inside the plasma reaction zone. Those that do not enter into reactions with other ions or break up serve to screen other ions. The H₂O molecule has an approximately 105-degree dipole, with partial charges on the two hydrogen atoms and the oxygen atom. These partial charges enable them to orient themselves as clusters around partially charged oxygen molecules and ions increasing their longevity. The gas is effectively stabilized until it contacts or is adsorbed onto the various carbonaceous film surfaces in the fly ash.

The dosing rate relative to fly ash will depend on the level of contamination and the particle size range—finer particles require higher dosage rates and certain types of fly ash are more intractable. As the aim is not to combust or react the carbon, provision of enough ions for coverage of the surface sites is the objective.

Within the scope of the present invention there are essentially three mechanisms; all operated at low temperature and all effectively surface oxidations that might be applied. In certain instances, to accommodate the variability or the intransigence of the contamination in the fly ash a combination of systems can be effective. The fly ash from a given power plant site ideally needs to be tested to determine the best sequence and level of energy for the treatment process. Hence, it may require photolytic breakdown with ultraviolet light, or microwave energy or ionized air or some combination of all three. The common thread is that the oxygen in the air is energized, largely without the conventional application of heat for example in a combustion process, leading to ionic formation and free radical reactions. Thus, ionized air alone, ionized air with ultraviolet radiation inside the contacting reactor to enhance the ionized air effect and/or microwave radiation to accelerate the reaction on the surface are all possible methods of enhancing the oxidation. Again it is emphasized that other than local surface heating of particles through reaction and radiant adsorption there is no wholesale heating of the gas stream or bulk of the mineral matter to combustion or near combustion temperatures. The process is carried out at low temperatures or substantially the mass of material is near or at ambient conditions. Some moisture in the air or the natural relative humidity of the ambient air is essential to the treatment process.

With both ultraviolet and microwave radiation, there is the need to contain these emissions within the contactor or reactor so that there is no harmful egress into the environment. However, the effect is localized and there are substantially no residual gases or chemicals that must be eliminated downstream.

Compared to ozone the power input required for the relevant amount of ionized air will be substantially less perhaps of the order of half of the power to make ozone and apply it to the fly ash. In addition, it might be expected that the capital cost of such equipment based on the principles indicated above will also be of the order of half of the ozone generator for similar duties.

It is possible to pass dilute phase solids in humid air through purposely designed plasma reactors and generate the ions in situ. Alternately, the desired treatment effect is obtainable by first making the ionized gas stream and then contacting the fly ash particles.

More generally, the ionized gas may be generated in the presence of the fly ash to be treated (so-called in situ generation of the ionized gas), such as in a common reactor volume where the fly ash treatment occurs, or the ionized gas may be produced separate from and not in the presence of the fly ash to be treated, such as in a separate reactor from the reactor in which the fly ash treatment takes place. Generally, processing that involves generation of the ionized gas in the presence of the fly ash to be treated is preferred.

The application of the ionize air or gas mixture to the fly ash is the next issue. Contact times and reactor geometries will be adapted from good engineering principles. These will include the ability to maximize the slip velocity or differential velocity of the particles relative to the gas stream—which in itself reduces the boundary layer effect and increases the overall mass transfer coefficient.

Suitable contacting devices range from pipeline or transfer line reactors, to fluidized beds, cyclonic reactors or especially toroidal fluidized beds as per U.S. Pat. No. 4,952,140 or 6,564,472, for example, (which have the high slip velocity mentioned earlier). In certain cases, the duty could be met with panel bed filter type configurations, packed and moving bed designs or even just baghouses adapted for the purpose. Depending on the level of contaminants, the application of ionized air may be made by injection into a silo or hopper containing the material. Here, the mixing and contacting may be poor but the residence time is extended. Contact times are a function of the device but can range from a few seconds to some minutes.

In another example of the disclosed process, solids pass through a fluidized zone or moving or agitated bed region in conjunction with a humid air flow. This zone has electrodes that effectively cause a whole set of plasma discharge reactions to occur inside the body of the gas-solid material or through the wall of the vessel to the moving particles. As this requires higher discharge potential, the voltage may be 20 KV peak to peak or more, even up to +/−60 kV. The frequency can be in the region of 60 Hz or above.

Again the reactions can be considered to be oxidations of the surface of the fly ash and the carbon content and involve the use of various oxygen species, ions and atomic oxygen, together with hydroxyl radical reactions due to the presence of the water vapor in the air stream.

In one embodiment, the reactor may be comprised of a cylindrical vessel with a central electrode and an outer (grounded) electrode made of stainless steel or woven copper cloth. The central electrode may be a solid rod or a wire. The walls of the vessel may be either a dielectric material like quartz or Teflon wrapped with a woven mesh or gauze forming the external electrode. With a dielectric wall, such as this, the rise and fall shape of the signal for the high voltage can be sinusoidal. The dielectric barrier more easily prevents short-circuiting than when the dielectric is absent. But a dielectric-free design is possible with a different electrical circuit design. An alternative reactor design is to have a solid steel wall, without a dielectric, such as stainless steel that is pulsed. The design of the electrical circuit requires higher switching slope—effectively a higher rate of rise and fall time—to prevent shorting and is better served with a pulse or a square wave.

The vessel may be a bubbling fluidized bed. The fluidization of the fly ash is achieved with velocities typically in excess of 4 cm/sec having regard to the particle size range for many ashes and preferably greater than 10 cm/sec superficial velocity. The fluidizing gas, which is humidified air, passes through a porous plate or a perforated disk having fine holes. The design of the particle—fluid flow conditions for this reactor are subject to the typical procedures and design rules for most fluidized beds. The solids flowrate into and out of the system is related to the fluidized volume so that the residence time of the majority of the particulate matter is sufficiently long to effect the desired reactions and change in the state of the surfactive-carbon within the fly ash. As the solids are actually integral to the plasma discharge zone there is a tendency for a reduction in the residence time when compared with the external methods of treatment, described earlier. However, many of the reactions and resulting surface effects are empirical and a degree of testing is essential. The fluidization requires that the gas flow is upward through the solids. Some very fine solids migrate or elutriate out of the vessel with the gas stream. As these tend to be the smaller particles, the gas phase contacting of these particles can take place quite rapidly in the freeboard above the fluidized bed or in the gas transit to the particulate collection equipment. Here, the excess ions are used up and reacted with this additional finely divided surface area.

### DRAWINGS

The accompanying drawings illustrate preferred embodiments of the present invention according to the best mode presently devised for making and using the instant invention, and in which:

FIG. 1 is a flowchart of a preferred example of the disclosed invention.

FIG. 2 is a flow chart of another example of the inventive steps disclosed here.

FIG. 3 is yet another example of the inventive steps disclosed here, the process being carried out through a fluidized-bed reactor of the type sold under the TORBED® trademark.

FIG. 4 is an example allowing for multiple reactors.

FIG. 5 illustrates a UV quartz reactor that may be used with the disclosed system to add exposure of ultra violet radiation to the fly ash.

FIG. 6 illustrates the use of ultraviolet radiation in a TORBED® type reactor.

FIG. 7 illustrates an embodiment of a plasma reactor used to treat the fly ash in accordance with the principles taught herein.

FIG. 7A illustrates an embodiment of a plasma reactor used to treat the fly ash in accordance with the principles taught herein, the example illustrating the use of dielectric beads.

FIG. 8 illustrates the use of a plasma reactor that includes a moving bed.

FIG. 8A illustrates the use of a plasma reactor that includes a moving bed and dielectric beads.

FIG. 9 illustrates the use of a reverse-operated cyclone with the plasma reactor.

FIG. 10 illustrates an example of a silo designed for treatment of fly ash at the power plant location.

FIG. 11 illustrates an embodiment of ionized gas treatment of fly ash transported through a reactor by belt conveyance.

FIGS. 12A and 12B illustrate an example of a configuration to aid mixing of fly ash during processing to expose fresh surfaces for treatment.

FIG. 13 illustrates an embodiment of ionized gas treatment of fly ash using a series of reactor stages with fly ash transported by belt conveyance.

FIG. 14 illustrates an embodiment of ionized gas treatment of fly ash with fly ash transport relative to a supporting substrate.

FIG. 15 illustrates an embodiment of an electrode configuration.

### DETAILED DESCRIPTION OF PREFERRED EXEMPLAR EMBODIMENTS

While the invention will be described and disclosed here in connection with certain preferred embodiments, the description is not intended to limit the invention to the specific embodiments shown and described here, but rather the invention is intended to cover all alternative embodiments and modifications that fall within the spirit and scope of the invention as defined by the claims included herein as well as any equivalents of the disclosed and claimed invention.

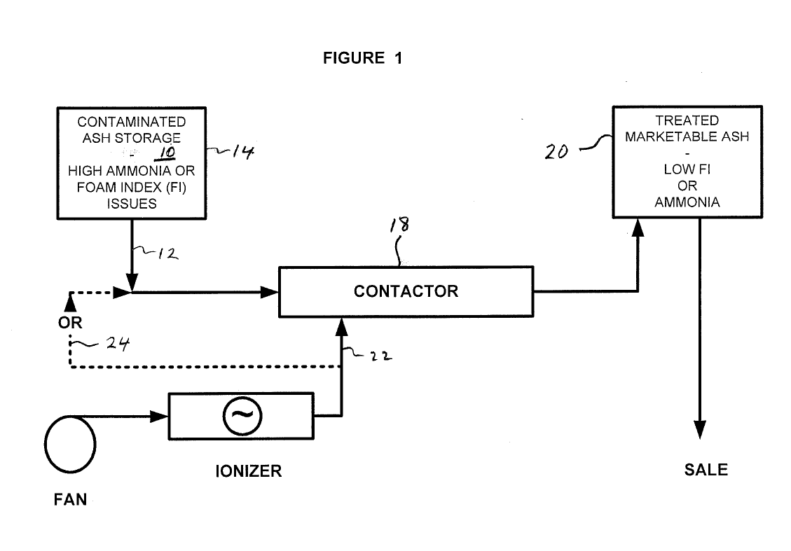

Turning now to the accompanying drawings, it will be understood that FIG. 1 indicates the conveyance of particulate fly ash 10 in a gas stream 12 from a feed hopper or silo 14, which contains the fly ash containing carbon to be treated, through a contactor or reactor 18 to a product hopper or silo 20. Generally, an ionized gas 22 can be an additive to the air stream that is conveying the fly ash. In certain cases, it may be appropriate to make all the ionized gas present in the conveying stream itself rather than by admixture. This is shown in FIG. 1 as the “or” case 24.

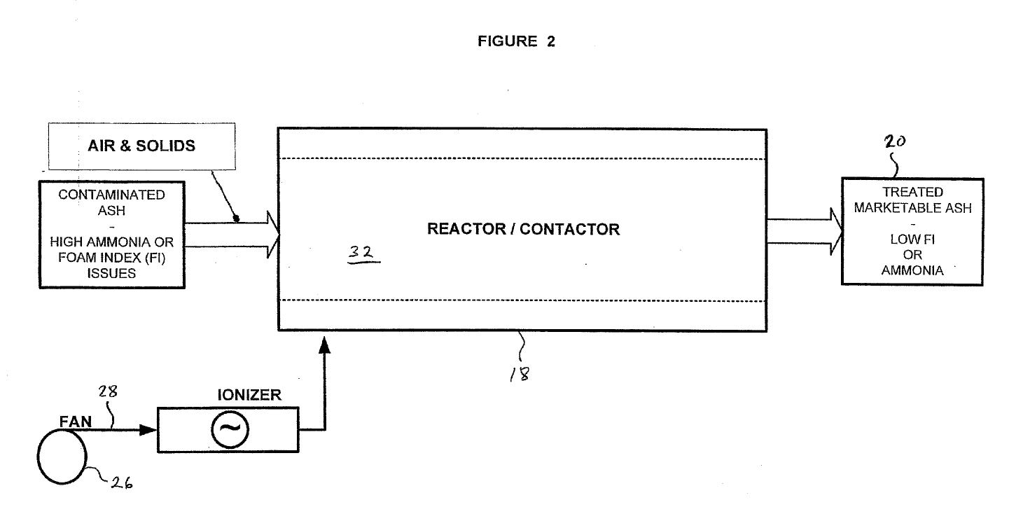

FIG. 2 shows the ionizer application with a fan delivering air through the energized zone 30 to the annular zone 32 of the reactor 18, carrying air and particles in at one end and out at the other. Although not shown here, it is also possible to design the ionizer with streamlined internals for actual passage of the solids in dilute phase through the reaction zone. In this case it is again important to have humidity in the transport air or gas so that the relevant species can be formed and interact heterogeneously with the fly ash surface. Hence, the plasma reactor itself and the contactor might be one and the same device, provided the solids are administered in a dilute or finely distributed phase.

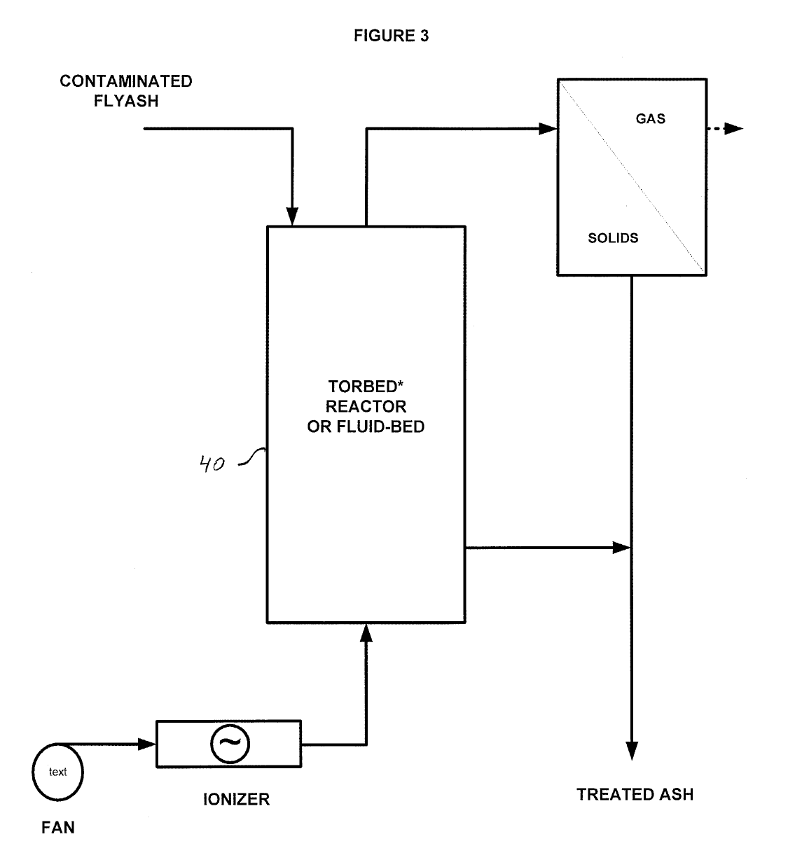

FIG. 3 depicts a reactor for improving the contact time or mixing of the gas with the solids through the agency of a fluidized bed or a TORBED® reactor 40. (TORBED is the registered trademark of Mortimer Technology Holdings Ltd., UK). This method of contacting has low pressure drop and high mass transfer coefficient between gas and particle. Either methodology has advantage where there is a need for extended residence time.

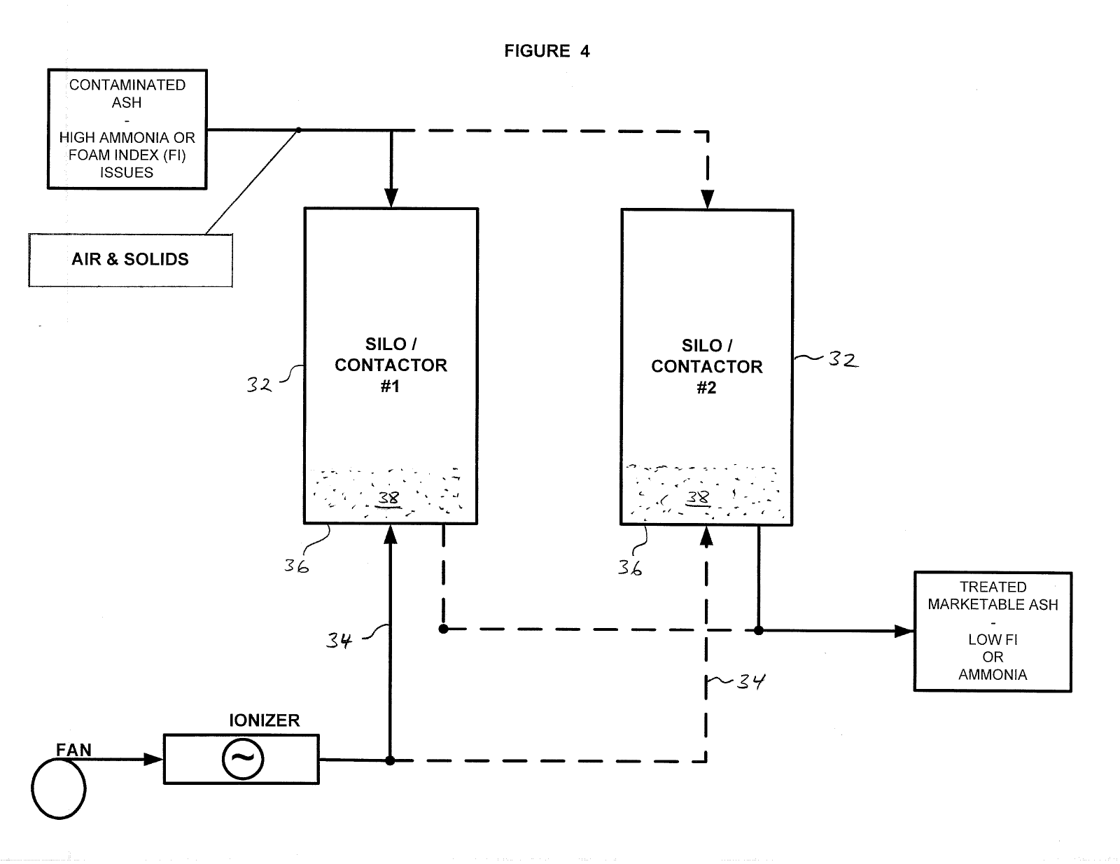

In other instances, ionized air could be applied direct to a silo alone or in addition to a transferring reactor or contactor delivering to the silo. FIG. 4 shows the silo method of implementing the proposed method of treatment. This applies to situations where there is a need for even more residence time for contact. Two silos 32 are shown adapted for passage of ionized gas 34 from the bottom 36 upwards through the packed bed of ash 38. Ionized gas is introduced as ash is fed counter-currently into the silos. The silos are cycled to treat material prior to discharge to truck or rail car.

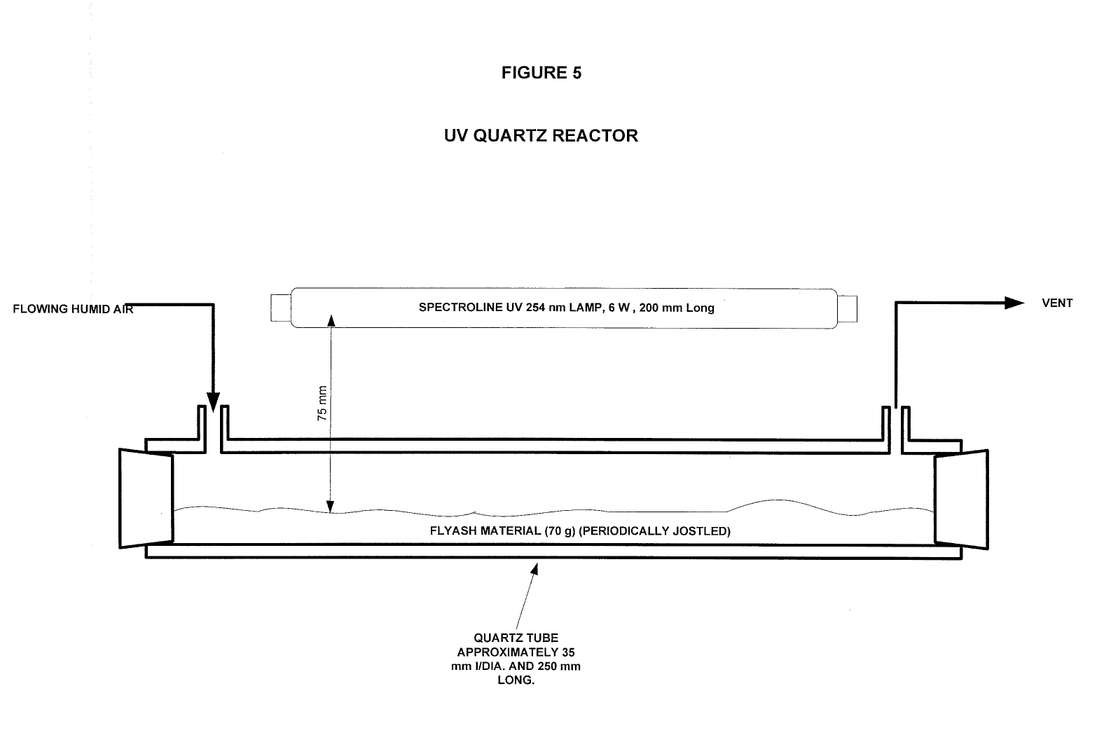

An experiment was carried out to determine if ultraviolet would effect ammonia breakdown reactions destroying ammonia compounds on fly ash. “Ultraviolet” covers a range of wavelengths ranging from short wave 254 nm to 312 nm, medium wave, to 365 nm, long wave, with the short wave being the most effective for rupturing of C—H bonds. Because N—H bonds have similar molecular bond energy it was thought that 254 nm wavelength UV might be effective at rupturing the bonds. The presence of humid air was thought to be advantageous due to the potential for formation of additional oxidizing species that are necessary for correction of foam index. The experiment therefore involved a sweep of humid air while the fly ash was irradiated. Being a surface reaction, an elongated geometry of reactor with shallow layer of fly ash was selected as shown in FIG. 5 below.

The mechanism for ultraviolet treatment is postulated to involve ammonia, as an adsorbed gaseous species only, and its breakdown into nitrogen and hydrogen due to the photolytic action:

2NH₃=N₂+3H₂

In the experiment, the uv light was operated intermittently on and off. During the off periods the fly ash was shaken to expose fresh material surface. With five periods of shaking, the sum of the “on” periods totaled 15 minutes and was therefore represented the total exposure time.

Exposure to ultraviolet light, UV-C at 254 nm, and 6 watts of power with 3 lpm of 50% RH airflow successfully produced a low ammonia level of 13.5 ppm in a C-ash having an untreated level of 121.5 ppm. It simultaneously had a foam index reduction from 95 to 75, (21%).

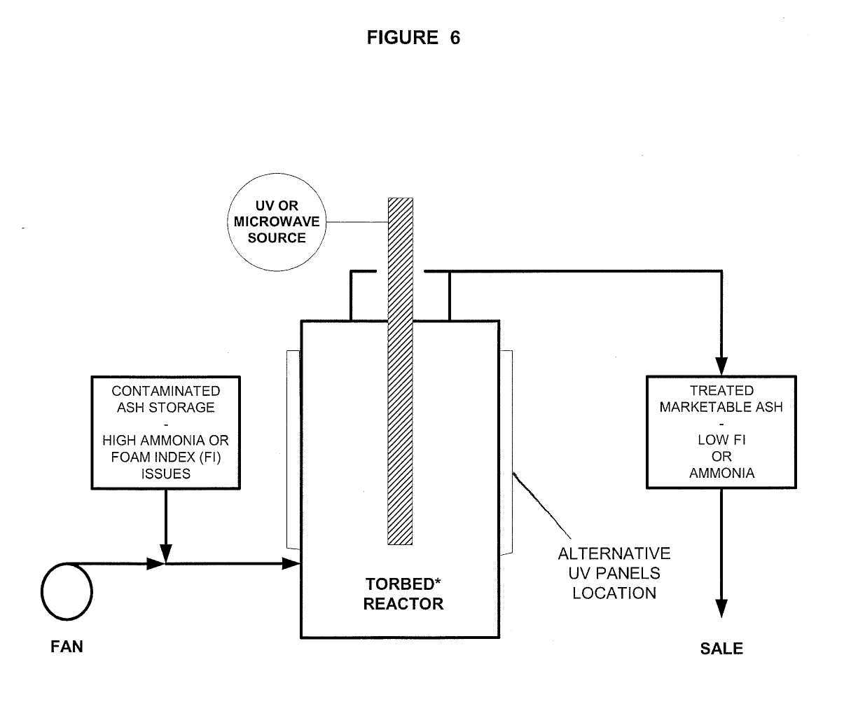

FIG. 6 depicts the in-situ application of ultraviolet radiation introduced down the center of a TORBED® reactor or alternatively through uv-transparent windows embedded in the sidewalls, (as an example of a preferred embodiment). The reactor alternatively could have a microwave system with a wave-guide positioned internal to the reactor to achieve the same effect and may or may not have a separate external generating source of ionized air. The diffuse cloud of particles that is generated inside this type of reactor is ideal for the radiation and mass transfer.

Unlike ozone, no significant residual breakdown equipment for excess gas or ionized species is envisaged as the high surface area of particulates and the heterogeneous reactivity of the species is likely to utilize the majority of the gas. It is however possible to provide for the eventuality of a small amount of breakthrough with a fabric filter containing some activated carbon or even manganese dioxide—operated at ambient temperatures.

An objective of the present invention is to simplify the application and hence the cost of the system so system arrangements where the ionized air equipment becomes a simple add-on are a substantial benefit in limiting the overall cost of treating the fly ash.

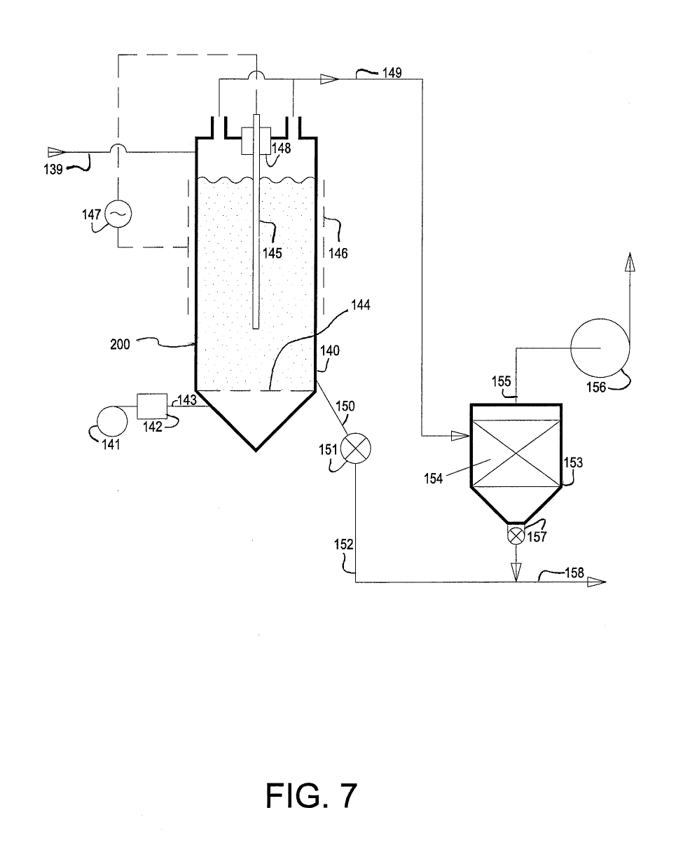

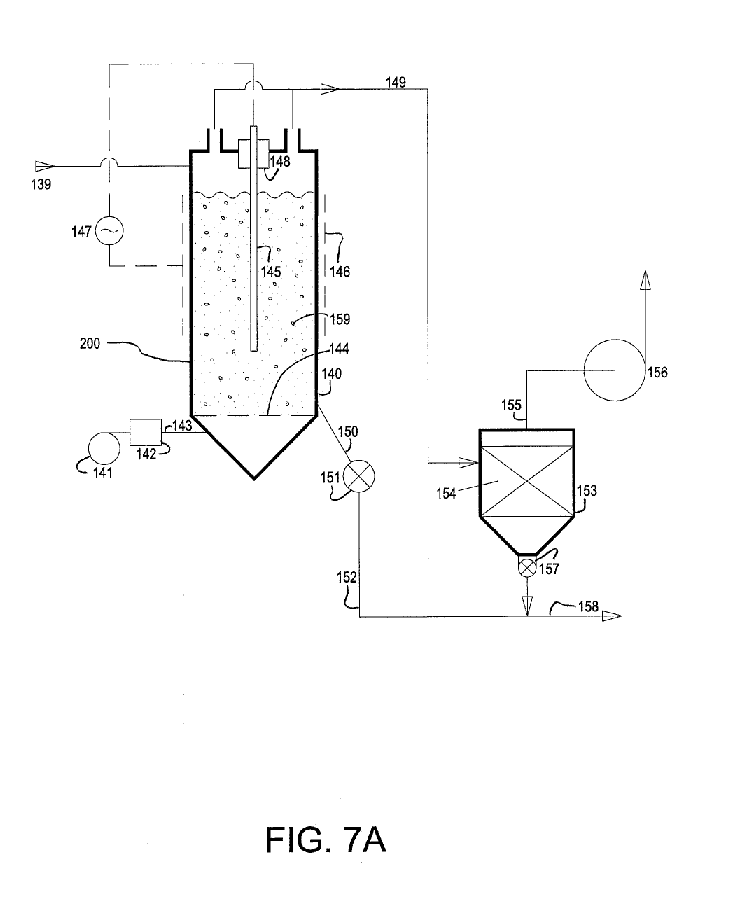

In FIG. 7, a vertical cylindrical fluidized bed vessel 140 represents a plasma reactor 200. The plasma reactor 200 has a feed port for solids 139 that introduces material at the top of the vessel 140. Air is passed via a fan 141, through a humidifier 142 (if necessary to humidify the air) and into duct 143 serving the fluid bed. A perforated plate or porous diffuser 144 provides distribution of the air and sufficient pressure drop to assure the even fluidization of the material in the bed. The high voltage switching circuit is made between the inner electrode 145 and the outer perforated metal or gauze electrode 146 and is driven by the high voltage switching circuit 147. The inner electrode passes into the fluid bed vessel through an insulator 148. The level of solids and hence the retention time are kept constant by control of the rotary valve 151, located on the outlet 150. The pressure drop of the bed or the level itself at the top can control the solids flowrate. It is also possible to arrange for the solids to be introduced at the bottom of the bed via, for example, a screw feeder and then simply overflow at the top without any level control, as such. The vessel working volume—depth for a given diameter—effectively determines the residence time of the solids for treatment. A discharge pipe 152, delivers the treated solids to a conveying system represented by 158. This could be a vibratory tube, screw conveyor, drag link or pneumatic conveyor.

The gas exiting the fluid bed via duct 149 may have fine material contained in it that needs to be recovered. This gas is drawn through a duct 155 and a bag filter 153 by an induced draft fan 156. In the filter, the solids are separated from the gas by fabric filtration media 154, selected for the temperature, particle size, and permeability that are required. Disentrained solids drop into the base of a hopper and pass out to the conveying system through an air lock valve 157. These solids meet those processed through the reactor. These solids are conveyed together through any one of a number of means, such as screw conveyors or drag link conveyors, represented by 158 to final treated ash collection.

In FIG. 7A, the design is similar to that of FIG. 7, except that the fluidized bed also contains a number of dielectric beads 159 made of a material like barium titanate (or glass) interspersed throughout. These are larger than the fly ash material but small enough to circulate with the majority of the bed material or they can be larger still and form a partial packed bed with the fine material interspersed and fluidized between them. The beads act like lenses and serve to concentrate the electrostatic field into the flowing fly ash solids. The discharge pipe 150 has a coarse perforated grid (not shown) at its inlet—the grid perforations are large enough to facilitate flow of the fine solids but not the dielectric beads so that these are retained in the vessel.

In another configuration, the gas and solids are contacted in a moving bed that has a central electrode and an outer electrode assembly. The flow of solids is generally downward under gravity being fed at the top and discharged at the bottom. The residence time for the solids overall in the system is determined by the dimensions of the vessel, the packing density of the particles in their moving state and the feed rate. Varying the flow rate of solids into the vessel, so as to maintain the level constant at the top is an easy way of controlling the residence time. The flow of humid air may enter the vessel at the bottom in countercurrent fashion or enter at the top with the solids and travel co-currently down the reactor with the solids. A vibrating central cone at the base causes the flow of solids down the reactor. A rotary valve, other vibratory system or air slide could be used to move and aid the flow in a similar fashion, or indeed the whole vessel could be vibrated to achieve this end.

The electrodes are arranged, as for the fluid bed. A central electrode, which is insulated from the walls and the reactor itself, operates at high voltage. The outer electrode consisting of a cylindrical gauze or perforated metal structure, being grounded, completes the circuit.

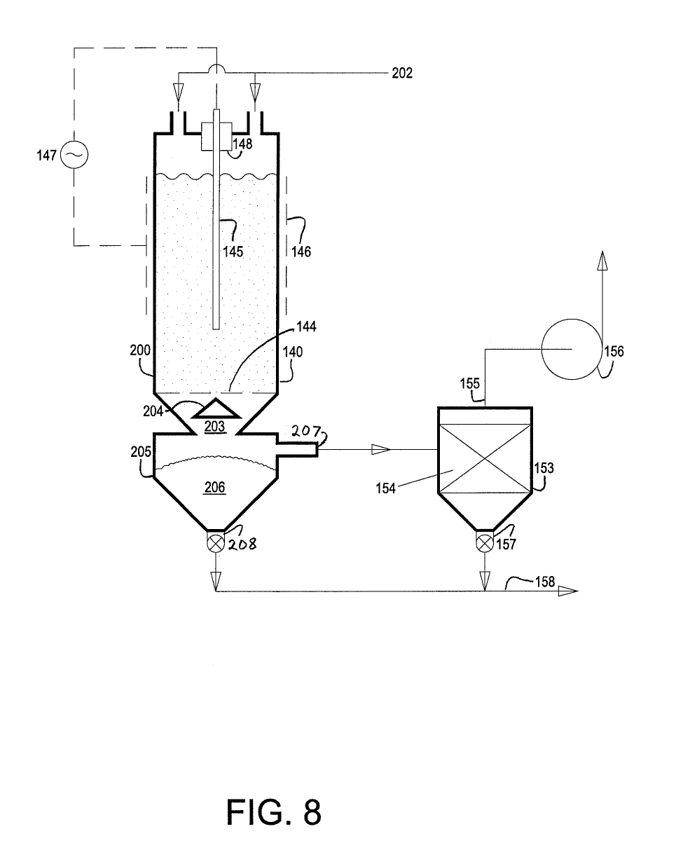

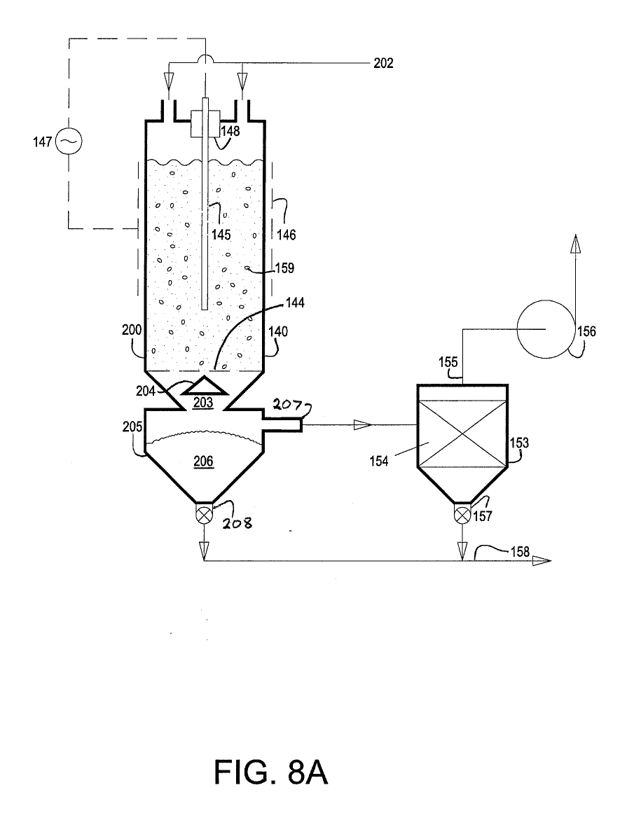

This type of plasma reactor—a moving bed arrangement—is depicted in FIG. 8. It consists of a vertical cylindrical vessel 140. This has two entry ports at the top 141, each designed to carry both humid air and the solids to be treated. The base of the vessel has a control throat 142, which has a conical plug 143 that can be adjusted up or down to increase or decrease flow and is vibrated. A grid 144 serves to assist in keeping the flow path uniform across the whole cross section (plug flow). The high voltage switching circuit is made between the inner electrode 145 and the outer perforated metal or gauze electrode, 46, and is driven by the high voltage switching circuit 147. The inner electrode passes into the vertical cylindrical vessel through an insulator 148. The co-current gas flow and solids are discharged through the throat 142 into an expanded chamber beneath, where the gas can disengage via outlet 150. Treated solids 152 collected in this vessel 149 are discharged periodically or continuously through a rotary valve 151. The exit gas is processed to remove solids through filter bags represented by 154, inside a bag filter 153. The gas is passed to atmosphere through an outlet duct 155 and fan 56. At the base of the bag filter 153 there is a discharge rotary valve 157 where discharged solids meet those processed through the reactor. These solids are conveyed together as described previously for the fluid bed configuration through a conveying system, 58, to final treated ash collection.

In FIG. 8A, the design is identical to that of FIG. 8 except that, inside the body of the reactor, there are a number of dielectric beads 159, which may be made of barium titanate (or glass) interspersed randomly throughout the vessel or as a packed bed. As described before, these act like lenses and serve to concentrate the electrostatic field into the flowing fly ash solids. The latter can pass through the perforated plate 144, at the base of the unit due to the vibration of plug 143. The dielectric beads, on the other hand, are larger than the grid perforations and preclude these exiting the reactor.

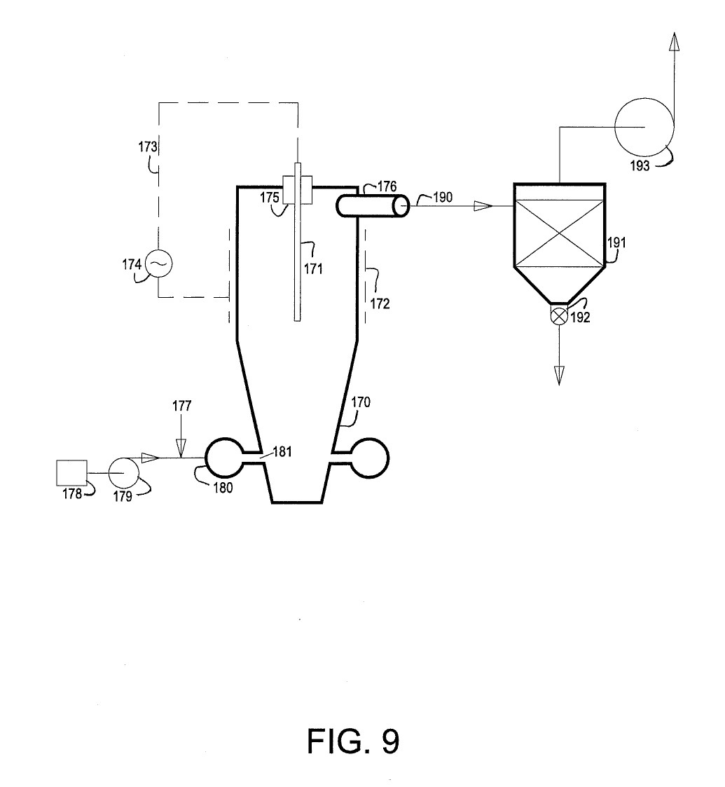

In FIG. 9, a reverse-operated cyclone 170 is shown. This has electrical features in common with the earlier examples, such as the central electrode 171 entering the vessel through insulator 175. The circuit is driven by the pulsed high voltage driver 174, making electrical connection with external electrode 172. As noted previously, the walls of the vessel may be a dielectric material like Teflon®, which serves to prevent short circuiting. Alternatively, they can be metal such as stainless steel and no dielectric barrier then exists between the electrodes other than the internal media. Air is drawn through a humidifier 178 by fan 179. Solids are conveyed into the gas stream from feed system 177—which could be a screw feeder or rotary valve feeding a source of untreated fly ash. The combined flow passes into a distributor 180, having a set of pipes 181 entering tangentially at the bottom of the truncated cone of the vessel. It is also possible to feed the solids into the vessel, separately from the humidified air, and at a different location but near the bottom of the vessel.

The flow of solids and gas is upwards through the reactor with all the solids being swept around and out with the gas. The solids residence time is less that with the other options above but is prolonged over the gas phase by virtue of centrifugal force generated by the high velocity swirl of the flow. The gas exits tangentially through off-take 176. Another option for handling the exit gas is a ring-collar outlet that surrounds the central electrode but is far enough away from it to prevent any shorting. The duct 90 conveys the whole gas and solid flow to separation in a filter unit 191 that is similar to that described previously. The system is aspirated by the induced draft fan 193, which discharges to atmosphere. The treated product solids are discharged via a rotary valve 192 to end use or sale.

Although not shown specifically in the diagrams, a TORBED® reactor (indicated earlier) can serve the process duty instead of a cyclone. It has the benefit of a longer solids residence time than a cyclone but less than a moving or fluidized bed.

The designer has to be cognizant of the different residence time requirements of the various types of reactor. The cyclone and the TORBED® reactor have a tendency to require higher gas to solids ratios, than the other types of reactor. However, the dispersed nature of the gas-solid envelope results in the plasma discharging through a film or cloud of the solids and gas, which can be very effective.

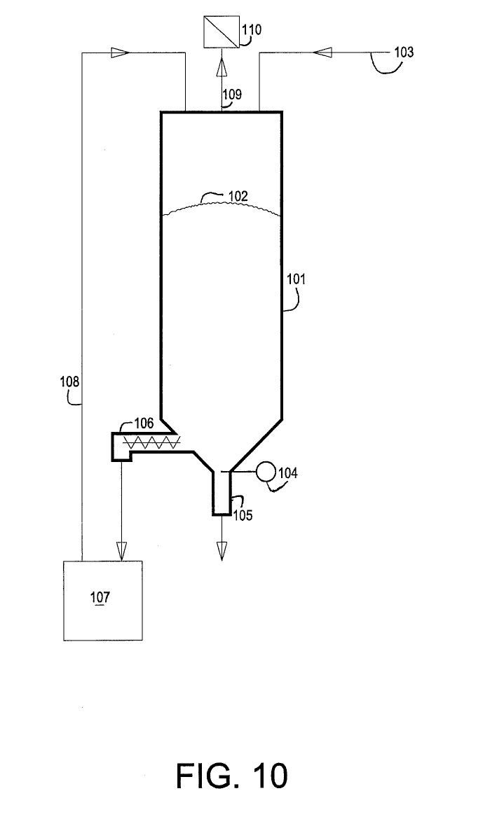

FIG. 10 illustrates a power plant fly ash silo and an indicative method of on-site treatment. Silo, 101, may be one of many to serve the fly ash production of a sizeable coal burning power plant. The normal operation of this is for collection of the dust from electrostatic precipitators via conveying line, 103. This is most often done pneumatically. The solids discharge into the silo and the conveying air is discharged through a duct, 109, to a filter, 110. When the silo is filled the flow is switched to a second or third silo as appropriate for the ash production. If the fly ash is directly marketable, it is discharged without treatment through a spigot, 105, to a waiting tanker truck. Multiple truck fills are possible with a large capacity silo.

If the ash is “off-specification” for direct sale because it has a high foam index, for example, on-site treatment may be considered. In this case assuming a near-full silo, 102, diverter valve, 104, may temporarily isolate the discharge to trucks and any new ash would be diverted to a second silo. A screw conveyor, 106, or other means is needed for controlling the discharge rate of the ash from the silo to the treatment system. The box 107 represents this treatment system. This process could be implemented in any one of the aforementioned types of reactor. The principle is that the flow would remain isolated from truck discharge for a period of time during which the silo contents are re-circulated through the treatment system and the beneficiated solids conveyed back to the silo by line 108. The time the silo is off-line would depend on its hold-up capacity, the treatment rate and the condition of the ash—but essentially, as a first order estimate, one turnover of the silo contents through the treatment process is necessary.

There are obvious integrations of this circuit that can be made. For example, the conveying line 108 may represent the exit from the cyclone or TORBED® reactor, where all the gas and solids pass together, and the bag filter equipment outlined in these examples could be replaced by the existing silo bag filter unit 110. It is also possible that either of the fluid or moving bed arrangements might utilize the silo filter for ultimate gas solid separation, in which case the vertical transfer line 108 would represent a bucket elevator for the solids. It is also conceivable that the re-circulation to the silo, via line 108, is not required in certain instances and that the treatment unit 107 can handle the fly ash as fast as it is discharged from the silo—effectively en route to the truck.

In one enhancement, the fly ash is treated in a shallow layer, or bed, of the fly ash particles, with ionized gas being generated in the presence of the fly ash primarily in a space within the reactor volume located above the layer of fly ash. In this way, it is believed that the treatment may benefit from the development of an ion avalanche in the space above the fly ash.

Because the effect of the ionized gas on the carbon within the fly ash appears to be largely a surface phenomenon, the dept of the layer should preferably be relatively shallow, typically having an average depth, and preferably also a maximum bed depth, in a range of 0.5 to 30 centimeters when the fly ash is contacted with the ionized gas. FIGS. 11, 13 and 14, discussed below, concern some particular embodiments involving treatment of fly ash in a relatively shallow layer with an ionized gas. In the embodiments illustrated in those figures, a layer of fly ash is moved relative to stationary electrodes. However, alternatives for processing could include designs with a stationary bed of fly ash and moving electrodes that traverse the length of the bed or both a moving bed and moving electrodes. Also, the layer of fly ash shown in those figures is illustrated as being of relatively uniform depth, but uniform layer depth is not necessary. The layer could be of varying depth, for example if the layer was supported in the bottom portion of a tube of circular cross-section, or on a conveyor not having a flat surface.

FIG. 11 illustrates one embodiment in which fly ash is treated when disposed in a relatively shallow layer, or bed. In the embodiment of FIG. 11, a layer of the fly ash is treated with ionized gas while the fly ash is supported on and transported by a moving conveyance substrate passing between electrodes generating an electrical field. As shown in FIG. 11, the moving conveyance substrate is in the form of a conveyor belt 302 travelling about rotating conveyor pulleys 304. The feed 306 of fly ash 308 is introduced into a feed hopper 310, from which the fly ash is delivered to a top surface of the moving belt 302 in the form of a layer 312 of fly ash supported on the belt. Movement of the belt 302 transports the fly ash through a reactor volume 314, in which are disposed multiple power electrodes 316. Ground electrodes 318 are located on the opposite side of the belt 302 from the corresponding power electrodes 316. The power electrodes 316 are electrically connected to a high voltage electrical power source 320, which provides electrical power to generate an electric field between the power electrodes 316 and the ground electrodes 318. Alternatively, the power electrodes 316 may be powered independently through connection to separate power supplies, rather than being powered by a common power supply as shown. As shown in the embodiment of FIG. 11, the power electrodes 316 are in the form of electrically conductive rods or wires (e.g., of electrically conductive metal) extending in a longitudinal direction across the width of the belt 302, and the ground electrodes 318 are in the form of electrically conductive plates (e.g., of electrically conductive metal) positioned to correspond in pairs with the power electrodes 316. Dielectric plates are disposed between each pair of corresponding power electrode 316 and ground electrode 318 to help prevent arcing between the electrode pairs.

A feed 322 of gas is introduced at an upstream end of the reactor volume 314. In a preferred implementation, the feed 322 of gas is ambient air or air humidified to a desired level. After introduction into the reactor volume 314, the flow of gas through the reactor volume 314 is generally in the same direction as the travel of the fly ash through the reactor volume 314, although a countercurrent flow arrangement is also possible. As the gas passes between the power electrodes 316 and the ground electrodes 318, it is ionized due to the influence of the electric field, generating ionized gas to treat the fly ash. Treated fly ash 324 exits from a downstream end of the reactor volume 314, and may be collected as a product by any suitable collection technique. Effluent gas 326 also exits from the downstream end of the reactor volume 314. The effluent gas 326 includes entrained ultrafine particles of fly ash. The effluent gas 326 is subjected to solid-gas separation in a separator 328 to produce a product 330 of treated ultrafine fly ash particles and a cleaned effluent gas 332. The separator 328 may be, for example, a cyclone separator, a bag filter or other filter design.

Because the treatment of the fly ash by the ionized gas appears to be largely a surface treatment phenomenon, effective treatment will tend to be enhanced and treatment times for effective treatment will tend to be reduced by mixing, or agitating, the fly ash during the treatment operation to expose new surfaces for effective contacting with the ionized gas. For example, in the processing shown in FIG. 11, fly ash near the top of the layer 312 supported on the belt 302 will tend to be more quickly and effectively treated than fly ash deeper in the layer below the surface, with fly ash next to the belt 302 tending to be most difficult to effectively treated. One enhancement to the processing as shown in FIG. 11 is to provide some added mixing of the fly ash on the belt while it is moving through the reactor volume 314.

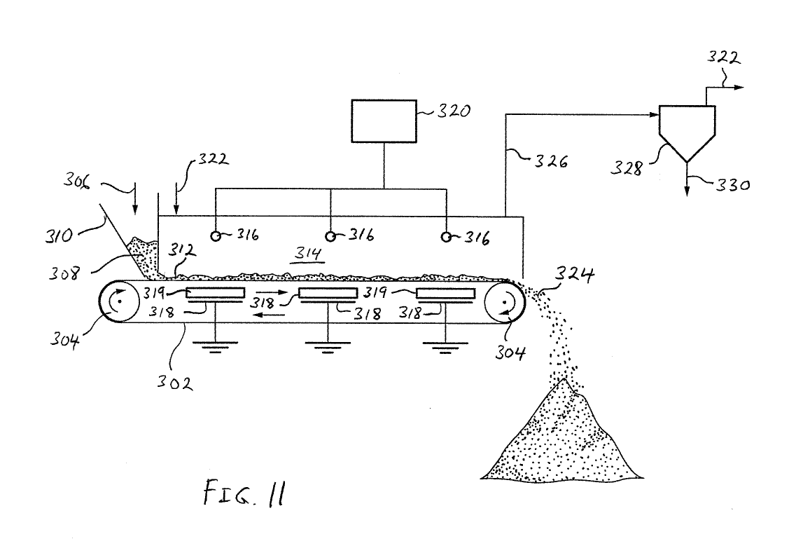

Referring now to FIGS. 12A and 12B, one embodiment for providing mixing of fly ash during treatment on a moving conveyance substrate is shown. As shown in FIGS. 12A and B, a moving conveyance substrate in the form of a belt 350 of a belt conveyor system has a top surface 352 on which fly ash would be supported for treatment. The arrows show the direction of movement of the belt 350 during operation. Located proximate to the top surface 352 of the belt 350 are a set of stationary, angled vanes 354, a mixing member 356 and a roller 358. In operation, fly ash supported on the traveling belt 352 would encounter the vanes, which would tend to move, or plough, the fly ash into a pile in the center portion of the belt 352. The mixing member 356 would then disrupt the pile to promote mixing of the fly ash, and the roller 358 would then re-position the fly ash into a layer of appropriate depth for further processing as the fly ash is transported on the belt 352. In this way, additional fly ash surfaces are exposed near the surface of the layer being treated for more effective contact with ionized gas. For example, referring again to the processing shown in FIG. 11, the mixing arrangement shown in FIGS. 12A and 12B could be incorporated within the reactor volume 314 between occurrences of the power electrodes 316, to provide for intermediate mixing of the fly ash on the belt 302.

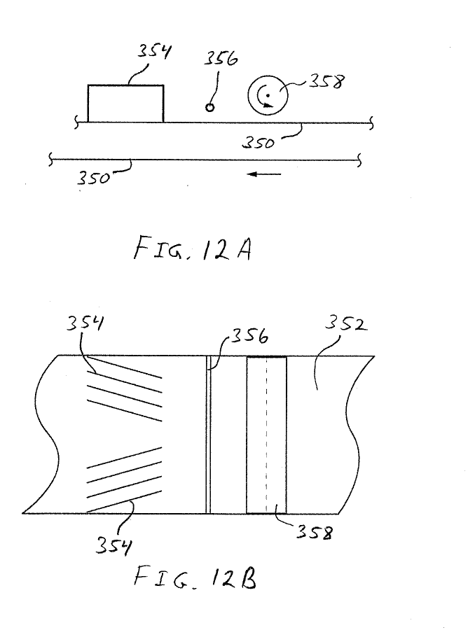

Treatment of fly ash may also be performed in stages. For example, processing of the type as shown in FIG. 11 could be performed in a series of stages, with each stage having a processing configuration generally of the type as shown in FIG. 11, and with intermediate mixing of fly ash between stages to expose additional fly ash surfaces for more effective treatment in the next succeeding stage. FIG. 13 shows one example of such staged processing with three treatment stages arranged in series, with each stage in the form of a conveyor reactor system generally of the type shown in FIG. 11. In FIG. 13, the first stage is identified as Stage 1, the second stage as Stage 2 and the third stage as Stage 3. The same reference numerals are used in FIG. 13 as are used in FIG. 11 to identify the same features of those described with respect to FIG. 11, except as noted. It will be appreciated that three stages are shown for the purpose of illustration only, and that a particular implementation may include more or fewer than three stages.

As shown in FIG. 13, each of the three stages includes the feed hopper 310 that delivers fly ash in a layer to the travelling belt 302, which transports the fly ash for treatment through a reactor volume 314 between corresponding pairs of power electrodes 316 and ground electrodes 318, with the belt 302 moving about conveyor pulleys 304. Feed 320 of gas is fed into the upstream end of each reactor volume 314 and effluent gas 326 is removed from the downstream and of each reactor volume 314. Entrained ultrafine fly ash particles contained in the effluent gas 326 are separated in the separator 328 to produce a combined product 356 of treated ultrafine fly ash and a combined cleaned effluent gas 358. Alternatively the effluent gas 326 from each stage could be processed separately.

The initial feed 306 of fly ash, however, is fed only to the first stage in series. Feed to the feed hopper 310 of each subsequent stage is provided by treated fly ash exiting the preceding stage, so that the partially-treated fly ash exiting from the first stage is mixed and agitated as it spills into the feed hopper 310 of the second stage, and the partially-treated fly ash exiting the second stage is agitated and mixed as it spills into the feed hopper 310 of the third stage. Therefore, fresh fly ash surfaces are exposed for treatment as the fly ash moves between the first and second stages and between the second and third stages. As an enhancement, agitators and/or vibrators (not shown) may be used to further promote mixing of the feed to each stage. For example, the feed hoppers 310 may be vibrated and/or equipped with an internal mixer or other agitator. Also, or alternatively, a separate mixing stage could be interposed between the reactor stages. Moreover, ash, mixing configurations such as those shown in FIGS. 12A and 12B could also be incorporated within one or more of the three stages shown in FIG. 13, for example between adjacent ones of the power electrodes 316. A final treated fly ash product 360 exits from the final stage. This final treated fly ash product 360 may be mixed with the product 356 of treated ultrafine fly ash to prepare a single combined treated fly ash product, or the products 360 and 356 may be maintained as separate products, which may have separate market applications and values.

It will be appreciated that the treatment configurations shown in FIGS. 11 and 13 could include more or fewer feed electrodes 316 or ground electrodes 318 than illustrated, and that the electrodes could be in different configurations than those illustrated, provided that the configurations are adequate in relation to the electrical field being used to generate the ionized gas within the reactor volume 314. Also, with careful control of power delivered from the high voltage electrical power source 320 (e.g., using high speed switching circuitry to produce a pulsed, fluctuating electrical field), the dielectric plates 319 could be eliminated from the configurations shown in FIGS. 11 and 13. Moreover, the belt 302 would ordinarily be made of a dielectric material, which would provide some additional protection against arcing, whether or not the dielectric plates 319 are used. For example, the belt 302 could be constructed from silicone rubber, polymeric (including polytetrafluoroethylenes, e.g., TEFLON®), fabric and/or other materials having high dielectric properties.

For FIGS. 11 and 13 illustrate some examples of processing relatively shallow beds, or layers, of fly ash with ionized gas generated in the presence of the fly ash in the same reactor volume in which the fly ash is treated. In the embodiments of FIGS. 11 and 13, the layer of the fly ash to be treated is supported on a moving conveyance substrate. Alternatively, however, the fly ash could be transported relative to a substrate on which the fly ash is supported during treatment. Also, although continuous or semi-continuous processing is generally preferred, the fly ash could alternatively be treated in a batch method.

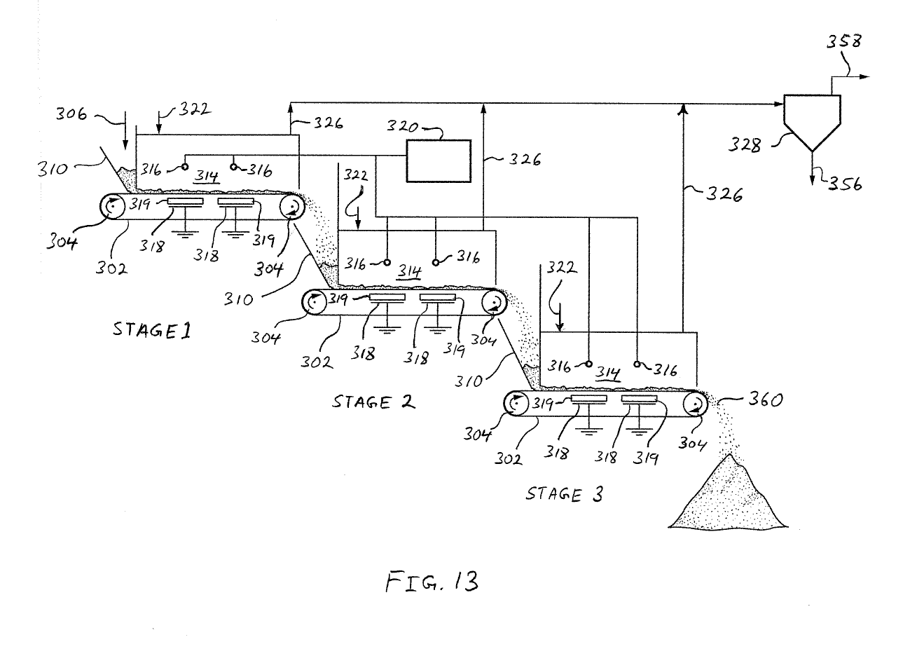

FIG. 14 shows one example embodiment for treatment of fly ash in a layer, or shallow bed, in which the fly ash is moved relative to a supporting substrate. As shown in FIG. 14, feed 370 of fly ash 372 is introduced into a feed hopper 374, from which the fly ash 372 exits onto substrate 376. The fly ash travels longitudinally along the surface of the substrate 376, generally in the direction of the arrows shown in the figure, from an upstream portion to a downstream portion of a reactor volume 378. As the fly ash travels through the reactor volume 378, it passes between a power electrode 380 and a ground electrode 382. The power electrode 380 is electrically connected with a high voltage electrical power source 384, which provides electrical power to generate a high voltage electrical field between the power electrode 380 and the ground electrode 382. A feed 386 of gas, preferably ambient air or air humidified to a desired level, is introduced into the upstream end of the reactor volume 378 and is ionized in the reactor volume 378 as it passes between the power electrode 380 and the ground electrode 382 to generate ionized gas for treatment of the fly ash passing between the power electrode 380 and the ground electrode 382. Treated fly ash 388 exits from the downstream end of the reactor volume 378, and may be collected in any convenient manner. Effluent gas 390 exits from the downstream end of the reactor volume 378 and is processed through a particle separator 392 to remove entrained ultrafine fly ash particles and prepare a product 394 of ultrafine treated fly ash particles and a treated effluent gas 396. To effect the movement of the fly ash along the substrate 376 through the reactor volume 378, the substrate 376 is vibrated, oscillated or otherwise manipulated to cause the fly ash to move through the reactor volume in the desired direction. Also, to assist fly ash transport, the substrate 376 may be slightly inclined downward in the direction from the feed hopper 374 toward the downstream end of the reactor volume 378. The substrate 376 preferably has dielectric properties to help prevent power arcing between the power electrode 380 and the ground electrode 382. For example, the substrate 376 may be made of, or comprise a contact layer made of, dielectric material. For example, the substrate 376 could be made of ceramic, glass, rubber, plastic, polytetrafluoroethylenes, e.g. TEFLON®, or other material with a high dielectric constant, or could also include a contact surface layer made from such materials or, for example, polytetrafluoroethylenes, e.g. TEFLON®, or silicone rubber. Moreover, one alternative to the implementation shown in FIG. 14 would be to have a tubular reactor with the fly ash disposed in the bottom portion of the tube, in a trough formed by the circular cross-section of the tube, with power electrode(s) located within the tube in the space above the fly ash and with the ground electrode(s) located outside of the tube below the fly ash, and with the tube being made of a dielectric material. Alternatively, the dielectric may be dispensed with by providing pulsed or high frequency switching rates (as previously mentioned and discussed further below) to provide a diffuse plasma discharge along the length of the vessel without formation of a power arc. Transport of the fly ash through the length of the tube could be facilitated by vibration of the tube, assisted by slight inclination of the tube if desired.

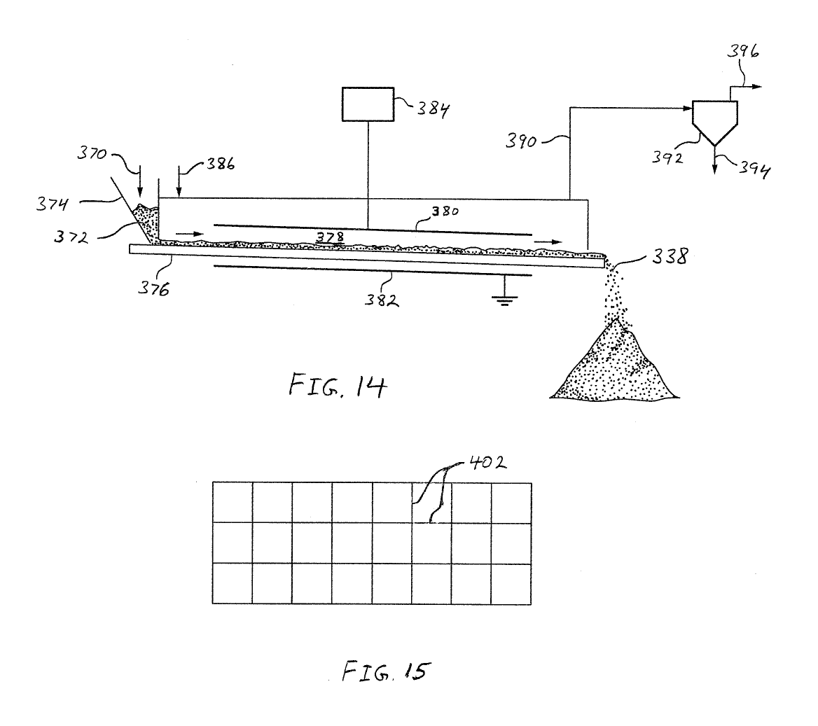

The embodiment shown in FIG. 14 includes only a single power electrode 380 and a single ground electrode 382. One possible configuration for the power electrode 380 is shown in FIG. 15, which might be appropriate for a planar (parallel) electrode arrangement. The power electrode shown in FIG. 15 includes a grid of electrically conductive metal members 402 (e.g., electrically conductive metal bars or wires). The ground electrode 382, as shown in FIG. 14, may preferably be provided in the form of an electrically conductive metal plate. As will be appreciated, any alternative configuration and arrangement of electrodes could be used instead, provided that the electrode configuration is adequate in relation to the electric field to be used and the gap is consistent between power electrodes and ground electrodes. For example, the electrode configurations shown in FIGS. 11 and 13 could be used instead in the embodiment of FIG. 14, and likewise, the electrode arrangement shown in FIG. 14 could be used in the embodiments of FIGS. 11 and 13 rather than the configurations shown in those figures. Moreover, if it was desired to provide additional agitation and mixing of the fly ash within the reactor volume 378 as shown in FIG. 14, additional mixing features could be incorporated at various locations along the substrate 376. For example, a mixing configuration such as that shown in FIGS. 12A and 12B, adapted to the context of the substrate 376 rather than a travelling belt, could be incorporated at one or more locations along the substrate 376 to assist in mixing and exposing new surfaces of the fly ash for treatment, in addition to the mixing provided by vibration, oscillation, etc. of the substrate 376. Moreover, multiple processing stages each having a configuration as shown in FIG. 14 could be arranged in series, similar to the arrangement shown in FIG. 13 for multiple conveyor belt configurations of FIG. 11.

As noted previously, the ionized gas may be generated in a separate operation and then contacted with the fly ash to be treated (e.g., FIGS. 1-4) or alternatively the ionized gas may be generated in the presence of the fly ash to be treated (e.g., FIGS. 7-11, 13, 14) (this latter alternative being referred to elsewhere herein as in situ generation of ionized gas). In any event, the ionized gas is generated by ionizing a gaseous feed comprising oxygen and water vapor. Advantageously, the gaseous feed has water vapor content at a relative humidity in a range having a lower limit selected from the group consisting of 15%, preferably 25% and more preferably 30% relative humidity and having an upper limit selected from the group consisting of 100%, preferably 75% and more preferably 70% relative humidity. As will be appreciated, relative humidity refers to the percentage of water vapor in the gaseous feed relative to the amount of water that would be in the gaseous feed if saturated with water vapor at the temperature and pressure conditions of the gaseous feed.

Preferred for use as a gaseous feed is either ambient air that has not been humidified prior to use or air that has been pre-humidified to a desired level (especially in the event that the ambient air does not contain a desired amount of water vapor). The temperature of the gaseous feed is preferably at least 10° C. and more preferably in a range of from 10° C. to 50° C. Increasing the content of oxygen in the gaseous feed relative to ambient air may be advantageous from a performance standpoint, but because of the added cost is not generally preferred. If used, an oxygen-enriched gaseous feed (i.e., enriched in oxygen relative to ambient air) may be prepared, for example, by mixing additional oxygen into air prior to use to generate the ionized gas, or the gaseous feed could comprise an oxygen-enriched stream separated from air, such as by membrane separation techniques.

Moreover, the amount of ionized gas used to treat a unit quantity of fly ash will generally vary depending upon the quantity of adsorbent-active surface area on the carbon contained in the fly ash being treated. By adsorbent-active surface area, it is meant the surface area of the carbon that is available to act as an adsorbent surface, as indicated by BET nitrogen adsorption surface area determinable through nitrogen adsorption testing. Advantageously, the treatment of fly ash using an ionized gas according to the invention typically may be performed using only a relatively small amount of ionized gas per unit quantity of adsorbent-active surface area of the carbon, typically in a range having a lower limit selected from the group consisting of 0.05, 0.1, 0.2, 0.5 and 1 gram of ionized gas per thousand square meters of adsorbent-active surface area of the carbon and an upper limit selected from the group consisting of 5.3, 2, 1, 0.6 and 0.5 grams of ionized gas per thousand square meters of adsorbent-active area of the carbon, provided that the upper limit is selected to be larger than the lower limit. Many fly ashes appear to be treatable within a range of 0.1 to 2 grams of ionized gas per thousand square meters of adsorbent-active surface area of the carbon, and of those an appreciable number of fly ashes appear to be adequately treatable within a range of 0.1 to 0.6, or even 0.2 to 0.5 grams of ionized gas per thousand square meters of adsorbent-active surface area of the carbon. As will be appreciated, the amount of ionized gas is equal to the amount of gaseous feed that is subjected to ionization to generate the ionized gas.

The amount of adsorbent-active surface area of carbon in the fly ash may vary greatly depending upon the quantity of carbon in the fly ash and the nature of the carbon in the fly ash. For example, F class fly ashes, such as may be produced with combustion of bituminous coals, often contain as much as 5 weight percent to 15 weight percent inherent carbon, while C class fly ashes, such may be produced with combustion of sub-bituminous coals, often contain only about 0.2 to 1.5 weight percent inherent carbon. By “inherent” carbon, it is meant that carbon contained in the fly ash that originates with the fuel, typically coal, that is being combusted in the combustion operation in which the fly ash is produced. This inherent carbon is distinguished from “added” carbon, which a fly ash may contain, but which does not originate with the combusted fuel. The source of added carbon is often from carbon added downstream of combustion to act as an adsorbent for mercury to assist in the removal of mercury vapor from flue gas. However, due to the different characteristics of the inherent carbon contained within the different fly ashes, C class ashes may have a higher level of adsorbent-active surface area of carbon per kilogram of fly ash than the F class ashes containing significantly more carbon. For example, carbon in F class ashes often have adsorbent-active surface area of from 10 to 100 square meters per gram of the carbon, whereas carbon in C class ashes often have adsorbent-active surface area of from 200 to 500 square meters per gram of the carbon. Moreover, some fly ashes may contain added carbon, often in the form of activated carbon, that was introduced during coal combustion operations, such as to aid in the capture of mercury released from the coal or other fuel during combustion. Such activated carbon is typically added in the form of a very fine grain powder known as powdered activated carbon (PAC). Such activated carbon often will have an adsorbent-active surface area of from 400 to 1500, or larger, square meters per gram of the carbon, and may be expected to be present in the fly ash in an amount of up to about 7 weight percent, and often in a range of from 0.2 weight percent to 5 weight percent.

The fly ash to be treated will typically contain between 0.2 and 10 weight percent carbon (including inherent carbon and any added carbon, activated or otherwise), and will typically have an adsorbent active surface area of the carbon of at least 500 square meters per kilogram of the fly ash. However, depending on the quantity and type of carbon present, the adsorbent active surface area per kilogram of fly ash may be considerably higher. For example, the fly ash containing 5 weight percent activated carbon may have perhaps 75,000 square meters of adsorbent-active surface area of the carbon. In most situations, however, it is anticipated that the fly ash will have between 500 and 90,000 square meters of adsorbent-active surface are of the carbon per kilogram of the fly ash.

One important application for the invention is for the treatment of fly ashes containing added carbon, often in the form of activated carbon, loaded with mercury, such as removed from flue gases following combustion of mercury-containing coal. The loading of mercury on activated carbon is often in the range from 0.5 to 1 milligrams of mercury per gram of the activated carbon. When the fly ash contains such added carbon to aid mercury capture, the fly ash may contain perhaps 3500 parts per billion mercury, and possibly more. However, it is anticipated that many fly ash materials containing mercury-loaded added carbon will contain from 1500 to 3500 parts per billion mercury. In one embodiment, all or a portion of the added carbon loaded with mercury is activated carbon, typically PAC. In another embodiment, all or a portion of the added carbon loaded with mercury is not activated carbon. For example, excess carbon from F class fly ashes may be added in combustion operations combusting coal that produces a C class fly ash. F class fly ashes tend to have a much greater capacity for capturing mercury than C class fly ashes. F class ashes tend to have higher carbon contents available for mercury adsorption than do C class ashes, and F class ashes also tend to contain more mercury captured in the form of precipitates (e.g., sulfide precipitates) than do C class ashes.

Use of fly ash containing activated carbon is problematic because of the extremely high adsorbent-active surface area associated with such carbon. Moreover, the traditional approach to reducing the adsorbent activity of carbon in fly ash involves thermal treatment to a level that would tend to volatilize mercury contained in the fly ash, which would be undesirable. However, with ionized gas treatment of the invention, the fly ash becomes treatable to reduce the capacity of the fly ash to adsorb air-entrainment surfactants without volatilizing the mercury during processing, due to the low temperature nature of the ionized gas treatment. Moreover, the mercury appears to remain stable on the carbon throughout and following the ionized gas treatment.

One aspect of the invention involves a product of mercury-containing fly ash, treated according to the process of the invention with an ionized gas, as a component of a product, or products containing such treated fly ash as a component, and use of such products. In one aspect, a method is provided for preparing a geotechnical composition or a concrete composition comprising combining the mercury-containing treated fly ash with one or more other components to prepare the composition. In relation to concrete compositions, such other materials may include, for example cement (e.g., Portland cement) aggregate (e.g., gravel, sand, rock), water and chemical additives (e.g., air entrainment surfactant). Such other components in relation to geotechnical compositions will include, for example, earth. By geotechnical composition, it is meant a composition containing earth and other additives for use as a structural component, such as in a retaining structure (e.g., dams, dikes, embankments) or a support structure (e.g., road beds, foundational supports). Such compositions, and the final structural forms taken by such compositions are within the scope of the present invention.

Importantly, most or substantially all mercury originally contained on the activated carbon prior to treatment with ionized gas appears to be retained on the activated carbon in the treated fly ash product. The retention of mercury following the treatment should, in any event, be larger than 90 percent of the mercury contained on the carbon prior to the treatment. Also, because of the low temperature operation of the ionized gas treatment, the activated carbon in the treated fly ash contains substantially all of the activated carbon in the fly ash as originally collected in the coal combustion operation.

Beneficially, the treatment using ionized gas according to the invention often achieves substantial reduction of the capacity of the fly ash, and particularly the carbon in the fly ash, to adsorb surfactants, and particularly air-entraining surfactants such as are used in concrete compositions. The surfactant-adsorbing capacity of fly ash is often determined based on the so-called foam index, or FI, discussed previously. The foam index is simply a numerical value indicating the number of drops, or the quantity of other measured quantities, of a test surfactant solution added to a unit quantity of fly ash material until the fly ash has adsorbed as much surfactant as it can. At the point the fly ash is saturated with adsorbed surfactant, the fly ash composition begins to froth, or foam, due to the presence of unadsorbed surfactant. With the ionized gas treatment of the invention, the surfactant-adsorbing capacity of the fly ash is typically reduced by at least 50%, and preferably by at least 70%, as indicated by a proportional drop in the numerical value of the foam index of the fly ash following the treatment relative to the fly ash prior to treatment. Moreover, in one embodiment, such reduction in the surfactant-adsorbing capacity of the fly ash is in relation to an air-entraining surfactant composition of 1% vinsol resin solution.

Another important aspect of the invention involves the potential for preparing a product of ultrafine treated fly ash particles. It has been found that during the treatment with ionized gas, ultrafine particles are produced from the fly ash. Although some of these particles may result from disaggregation of previously agglomerated materials, it appears as though a significant portion of such ultrafine particles are formed by fragments of fly ash being broken off of larger particles during the ionized gas treatment. This production of ultrafines appears to be promoted especially in the case of processing in which the ionized gas is produced in the presence of the fly ash in a common reactor volume. The ultrafine particles have been found to typically have very low or negligible surfactant-adsorbing capacity. Moreover, the ultrafine particles are of an advantageous size for incorporation into products, and especially into concrete compositions. In that regard, such ultrafine particles typically have a size of smaller than about 10 microns, and often in a range of from about 0.2 to 5 microns. These properties of very low surfactant-adsorbing capacity and small particle size are particularly advantageous, and are beneficial to the final treated fly ash product even when collected in a bulk product along with the coarser fly ash particles. However, with one implementation of the invention, a separate product of such ultrafine particles is collected, such that both a bulk product of the treated fly ash is collected and a separate product is collected that is comprised primarily of such ultrafine particles. Collection of ultrafine particles in a separate product is shown, for example, in the example implementations of FIGS. 11, 13 and 14, where an appreciable portion of such ultrafine particles are entrained in the gas stream for separate recovery. Moreover, even when ultrafine particles are collected primarily in a bulk product with the coarser particles, a separate product of the ultrafines may be prepared by size separation from the bulk product, such as, for example by cyclone separation. In one embodiment, approximately 1 to 8 weight percent of the total amount of the treated fly ash is processed into a separate ultrafine product, either by collection directly as a separate product from the treatment operation or by separation from a bulk product. Such ultrafine treated fly ash products often have a weight average particle size of smaller than _{—}8 microns and often also larger than 1 micron, and often in a range of from 1 to 5 microns. In this embodiment, the treated fly ash is comprised of an ultrafine fraction having a weight average particle size of smaller than 8 microns, and often in a range of 1 to 5 microns, and a coarse fraction having a weight average particle size of larger than 10 microns, and often much larger, and with the ultrafine fraction often comprising from 1 to 8 weight percent of the total fly ash. The ultrafine and coarse fractions may be collected together in a bulk product, or some or all of the ultrafine fraction may be collected separately in a separate ultrafine product of the type noted above. In one aspect, the invention provides a fly ash product comprising the ultrafine particles, either in such a separate ultrafine product or in a combined product with coarse fraction fly ash particles.

For ionized gas treatment of fly ash, the electrical field to which the feed gas is subjected must be sufficient to produce the desired ionized gas, which is in the form of a plasma. To produce such ionization of the gas, a high voltage electrical field is desired. Typically, the electrical field will result from an applied electrical power with a peak voltage in a range having a lower limit selected from the group consisting of 7 kilovolts, 10 kilovolts, and 15 kilovolts and an upper limit selected from the group consisting of 60 kilovolts, 40 kilovolts and 25 kilovolts. By peak voltage, it is meant the maximum voltage applied between a pair of electrodes to generate the electrical field. In a preferred implementation the electrical field is a fluctuating electrical field in that the applied voltage changes as a function of time. For many applications, operation at a peak voltage in a range of 10 to 25 kilovolts is preferable. However, in processing options where it is desired to produce an ionized gas from gas flowing through or contained within a bed or other bulk volume of fly ash, higher peak voltages in a range of 20 to 60 kilovolts are preferred. This latter situation would be the case, for example, for embodiments such as those shown in FIGS. 7-10. In the fluctuating electrical field, the voltage of the electrical field is changing with time, typically cycling between higher and lower (including zero) voltage values, which in one preferred implementation is accomplished through rapid on/off switching of an applied DC voltage from a high voltage DC electrical power source through the use of high speed switching circuitry. Such fluctuating electrical field may, for example, be in the nature of voltage pulses produced through such high speed switching on and off of the electrical power to the electrodes, approximating a square wave pattern for the applied voltage. As noted previously, the voltage rise and fall in the fluctuating field should be greater than 106 volts per second.

Use of such a fluctuating electrical field is advantageous in helping to prevent power arcing during the treatment operation. Another way to help prevent power arcing is to include a dielectric material disposed between power and ground electrodes, as is shown in many of the implementations described in the figures. However, the need for such intermediate dielectric material is reduced, and may in some case be entirely eliminated, through appropriately rapid fluctuation of the applied voltage.

Another aspect of the invention involves reduction or elimination of ammonia from fly ash materials. Fly ashes containing ammonia may be subjected to ionized gas treatment to reduce (including elimination of) ammonia. The ionized gas treatment may be as described previously with respect to treatment of fly ashes containing carbon to reduce the surfactant-adsorbing capacity of the carbon. Ionized gas treatment to reduce ammonia may be performed whether or not the fly ash also contains carbon to be treated for reduction of surfactant-adsorbing capacity. Alternatives to ionized gas treatment for reduction (including possible elimination) of eliminate ammonia according to the invention are to treat the fly ash with one or both of microwave energy or ultraviolet energy. One or both of such microwave or ultraviolet treatment may be performed instead of or in addition to treatment with ionized gas. One preferred implementation is the use of ultraviolet light, instead of or in addition to ionized gas treatment, for reduction of ammonia content in the fly ash. Also, treatment with ultraviolet radiation will be enhanced with treatment techniques that provide for a high level of exposure to the ultraviolet radiation of surfaces of the fly ash being treated. Some suitable examples include those described with respect to FIGS. 5 and 6. Moreover, the ionized gas treatment designs described with respect to FIGS. 11, 13 and 14 are also adaptable to instead perform an ultraviolet treatment, by removing the electrodes and replacing the power electrodes with ultra-violet radiation sources located above the layer of the fly ash to be treated. When using such implementations adapted for ultraviolet treatment, the bed depth in the layers of fly ash being treated should be kept to a shallow depth (preferably within a preferred range of 0.5 to 30 centimeters disclosed previously for ionized gas treatment) and subjected to frequent mixing to expose new surfaces for exposure to the ultraviolet radiation. In a preferred implementation, the treatment (whether ionized gas, microwave, ultraviolet, or a combination thereof) is conducted to an extent to reduce the ammonia content by at least one-half, and more preferably to reduce the ammonia content by at least 75 percent.

It will be appreciated that the above-described embodiments are illustrative of just a few of the numerous variations of arrangements of the disclosed elements used to carry out the disclosed aspects of the invention. Moreover, while the invention has been particularly shown, described and illustrated in detail with reference to preferred embodiments and modifications thereof, it should be understood that the foregoing and other modifications are exemplary only, and that equivalent changes in form and detail may be made without departing from the true spirit and scope of the invention as claimed, except as precluded by the prior art.

What is claimed is:

1. A method for treating particulate, carbon-containing fly ash comprising carbon having a surfactant-adsorbing capacity, the method comprising:
generating an ionized gas, the generating comprising ionizing an oxygen-containing gaseous feed having a relative humidity of at least 15 percent;
contacting a feed of the carbon-containing fly ash with the ionized gas sufficient to reduce the surfactant-adsorbing capacity of the carbon during the contacting;
following the contacting, collecting a treated fly ash having reduced surfactant-adsorbing capacity relative to the feed of the fly ash.

2. The method of claim 1, wherein the gaseous feed comprises ambient air.

3. The method of claim 2, wherein the ambient air is not dried to reduce humidity prior to the generating.

4. The method of claim 3, wherein the gaseous feed consists essentially of ambient air.

5. The method of claim 1, comprising prior to the generating, preparing the gaseous feed, the preparing comprising humidifying an oxygen-containing gas.

6. The method of claim 5, wherein the oxygen-containing gas consists essentially of ambient air.

7. The method of claim 1, comprising simultaneously performing in a common reactor volume at least a portion of the generating and at least a portion of the contacting.

8. The method of claim 7, wherein the simultaneously performing comprises disposing a volume of fly ash between two electrodes generating an alternating electrical field that ionizes the gaseous feed in the presence of the fly ash.

9. The method of claim 8, wherein the alternating electrical field comprises a peak voltage in a range of from 7 kV to 60 kV.

10. The method of claim 9, wherein the peak voltage is in a range of from 10 kV to 25 kV.

11. The method of claim 9, wherein the electrical field comprises a voltage rise and fall exceeding 10⁶ volts per second.

12. The method of claim 9, wherein the simultaneously performing is conducted substantially in the absence of a dielectric, other than the fly ash, disposed between the electrodes and substantially in the absence of electrical arcing between the electrodes.

13. The method of claim 9, wherein the volume of fly ash is in a layer having a depth in a range of from 0.3 cm to 50 cm.

14. The method of claim 13, comprising mixing the fly ash between a first portion of the contacting and a second portion of the contacting, to enhance exposure of different portions of the fly ash to the ionized gas during the contacting.

15. The method of claim 13, wherein the layer of fly ash is supported on a moving conveyance substrate passing between the electrodes.

16. The method of claim 13, wherein the layer of fly ash comprises a moving bed of the fly ash passing between the electrodes.

17. The method of claim 1, comprising performing at least a portion of the generating in a separate reactor volume in the absence of the fly ash to generate at least a portion of the ionized gas, which is then contacted with the fly ash during the contacting.

18. The method of claim 1, wherein the carbon in the fly ash comprises an adsorbent-active surface area of at least 500 square meters per kilogram of the fly ash.

19. The method of claim 18, wherein the fly ash comprises at least 0.2 weight percent of the carbon.

20. The method of claim 19, wherein the carbon comprises added carbon loaded with mercury captured following release of the mercury during combustion of mercury-containing coal.

21. The method of claim 20, wherein the fly ash comprises from 1500 to 3500 parts per billion by weight of mercury.

22. The method of claim 21, wherein the treated fly ash comprises substantially all of the mercury from the feed of the fly ash.

23. The method of claim 18, wherein the contacting comprises exposing the fly ash to from 0.05 gram to 5.3 grams of the ionized gas per thousand square meters of the adsorbent-active surface area of the carbon.

24. The method of claim 23, wherein during the contacting, the surfactant-adsorbing capacity of the fly ash, as measured for a 1% vinsol resin solution, is reduced by at least 50%.

25. The method of claim 1, wherein the relative humidity of the gaseous feed is no larger than 75%.

26. The method of claim 1, wherein the relative humidity of the gaseous feed is in a range of from 25% to 70%.

27. The method of claim 1, wherein the temperature of the gaseous feed is at least 10° C.

28. The method of claim 27, wherein the temperature of the gaseous feed is in a range of from 10° C. to about 50° C.

29. The method of claim 1, wherein:
the carbon in the fly ash comprises an adsorbent-active surface area of at least 500 square meters per kilogram of the fly ash;
the gaseous feed consists essentially of air at a temperature in a range of from 10° C. to 50° C. and having a relative humidity of from 25% to 70%;
the generating comprises subjecting the gaseous feed to an alternating electrical field having a peak voltage of from 10 to 60 kilovolts and a voltage rise and fall exceeding 106 volts per second; and
the contacting comprises exposing the fly ash to from 0.2 gram to 2 grams of the ionized gas per thousand square meters of the adsorbent-active surface area of the carbon.

30. The method of claim 29, comprising simultaneously performing in a common reactor volume at least a portion of the generating and at least a portion of the contacting.

31. The method of claim 1, wherein the treated fly ash collected during the collecting comprises from about 1 weight percent to about 8 weight percent of ultrafine particles having a weight average particle size of from 1 to 8 microns.

32. The method of claim 1, comprising preparing an ultrafine product of the treated fly ash having a weight average particle size of smaller than 8 microns and a separate coarse product of the treated fly ash having a weight average particle size of larger than 10 microns.

33. The method of claim 32, wherein the ultrafine product comprises from 1 to 8 weight percent of the fly ash collected during the collecting.

34. The method of claim 1, comprising preparing a concrete mixture comprising at least a portion of the treated fly ash.

35. The method of claim 22, comprising preparing a concrete mixture comprising at least a portion of the treated fly ash.

36. The method of claim 1, comprising preparing a geotechnical composition comprising a earth and at least a portion of the treated fly ash.

37. Concrete comprising treated fly ash prepared according to the method of claim 1.

38. Concrete comprising treated fly ash prepared according to the method of claim 22.

39. A product comprising treated carbon-containing fly ash having reduced surfactant-adsorbing capacity relative to the fly ash as originally collected from a coal combustion operation, the treated carbon-containing fly ash product comprising:
0.3 to 5 weight percent activated carbon loaded with mercury removed from flue gas in a coal combustion operation, wherein the activated carbon in the treated fly ash includes substantially all of the of the activated carbon in the fly ash as originally collected in the coal combustion operation; and
the fly ash having a surfactant-adsorbing capacity of no larger than 50% of the surfactant-adsorbing capacity of the fly ash as originally collected in the coal combustion operation.

40. The product of claim 39, wherein,
the treated fly ash comprises substantially all of the mercury contained in the fly ash as originally collected in the coal combustion operation.

41. The fly ash product of claim 39, comprising from 1500 to 3500 ppb mercury per kilogram of the fly ash.

42. The product of claim 39 in the form of a concrete composition comprising the treated fly ash.

43. A method for treating particulate fly ash comprising ammonia for reduction of the ammonia content in the fly ash, the method comprising:
generating an ionized gas, the generating comprising ionizing an oxygen-containing gaseous feed having a relative humidity of at least 15 percent;
contacting a feed of the carbon-containing fly ash with the ionized gas sufficient to reduce the ammonia content in the fly ash by at least half,
following the contacting, collecting a treated fly ash having reduced ammonia content.

44. A treated ultrafine fly ash product with low or negligible surfactant-adsorbing capacity, comprising:
a weight average particle size in a range of from 1 micron to 8 microns;
carbon surface treated with ionized gas to reduce surfactant-adsorbing capacity of the carbon.

45. A method for treating particulate fly ash comprising ammonia for reduction of the ammonia content in the fly ash, the method comprising:
exposing the fly ash to ultraviolet radiation sufficient reduce the ammonia content in the fly ash by at least half;
following the exposing, collecting a treated fly ash having reduced ammonia content.
